(19) United States
(12) Patent Application Publication
(10) Pub. No.: US 2026/0274735 A1
(43) Pub. Date: Sep. 17, 2026

(54) LASER WELDED GLASS ARTICLE AND METHOD OF MANUFACTURING THE SAME USING A WELDING EMISSION WITH BEAM WAIST SEPARATED FROM INTERFACE BETWEEN GLASS COMPONENTS TO BE LASER WELDED

(71) Applicant: Corning Incorporated, Corning, NY (US)

(72) Inventor: Anatoli Anatolyevich Abramov, Painted Post, NY (US)

(21) Appl. No.: 19/556,567

(22) Filed: Mar. 4, 2026

Related U.S. Application Data
(60) Provisional application No. 63/771,712, filed on Mar. 14, 2025.

(51) Int. Cl. C03B 37/012; B32B 17/06; C03B 23/207

(52) U.S. Cl. CPC C03B 37/01205; B32B 17/06; C03B 23/207

(57) ABSTRACT

A laser welded glass article including: (a) a first glass component comprising an inward primary surface and an outward primary surface; (b) a second glass component fused to the first glass component, the second glass component including an inward primary surface and an outward primary surface, the inward primary surface of the second glass component facing the inward primary surface of the first glass component; and (c) laser weld volume fusing the first glass component and the second glass component together, the weld volume comprising an hourglass, vortex, or conical shaped perimeter. A fiber preform as the laser welded glass article is additionally disclosed. A method of manufacturing the laser welded glass article is further disclosed.

### CROSS-REFERENCE TO RELATED APPLICATION

This Application claims the benefit of priority to U.S. Provisional Patent Application Serial Number 63/771712 filed on Mar. 14, 2025, the content of which is relied upon and incorporated herein by reference in its entirety.

### TECHNICAL FIELD

The present disclosure pertains to a laser welded glass article with laser weld volume having an hourglass, vortex, or conical shaped perimeter fusing a first glass component and a second glass component and, more particularly, to an optical fiber preform with such laser weld volumes fusing inner preform tubes to an outer preform cladding.

### BACKGROUND

An optical fiber can be utilized to transmit an electromagnetic radiation signal across a distance. In a traditional design, the optical fiber includes a solid core through which the signal transmits and a solid cladding disposed radially around the solid core. The solid core and the solid cladding have different indices of refraction. The signal thus largely stays confined within the solid core during transmission because of total internal reflection at the interface between the solid core and the solid cladding. The utilization of the solid core limits the speed at which the optical fiber can transmit the signal (e.g., an inherent minimum latency), limits the power of the signal that can be transmitted, imposes a degree of attenuation of the signal, and introduces non-linear effects such as four-wave mixing.

To address the limitations of the solid core based optical fiber, optical fibers with a hollow core have been proposed. With such an optical fiber, there is no solid core but rather a hollow core. Various ways of maintaining the signal within the hollow core have been utilized – one of which is anti-resonance. With anti-resonance, the cladding is engineered with the operating wavelength of the signal in mind so that the cladding reflects the signal back into the hollow core and largely prevents transmission of the signal through the cladding. An example of such a cladding are hollow tubes that run axially with the transmission axis through the hollow core. The hollow tubes are placed radially around the transmission axis to define the hollow core and have a thickness at which the hollow tubes do not resonate with the signal but rather reflect the signal to maintain the signal within the hollow core. Such optical fibers are typically referred to as anti-resonant hollow core optical fibers or ARFs for short.

Techniques to manufacture ARFs are under development. However, like solid core optical fibers, the techniques typically all include drawing the ARF from a fiber preform that is structurally similar to the ARF but with thicker components. Fabrication of the fiber preform may require precise spatial placement of the preform cladding tubes relative to each other and a surrounding outer cladding. To obtain the precise spatial placement, it has been proposed to fuse the inner preform tubes and the surrounding outer preform cladding together. Such fusion has heretofore been achieved using an open flame to weld the components.

However, those manufacturing techniques cause various problems. First, use of the open flame can cause particle deposition on the preform components such as the inner preform tubes and the outer preform cladding. As the open flame causes the preform components to increase in temperature, particles of material such as silica soot and contaminants are released. The particles then deposit elsewhere on the components. The deposition of the particles is problematic because the particles may cause the hollow core optical fiber ultimately drawn from the fiber preform to exhibit suboptimal transmission and mechanical performance. The particles could be removed from the fiber preform before draw of the optical fiber. However, such remediation efforts are difficult to perform and, in any event, suboptimal in terms of cost and time.

Second, the use of the open flame poses additional problems in that the components of the fiber preform can become distorted, a consequence of the open flame heating a relatively large volume of the preform components. The distortion can cause the components of the fiber preform to distort outside of predetermined dimensional tolerances. The fiber preform may then need to be scrapped. Even if not, the change in dimensional tolerances may be carried over to the hollow core optical fiber drawn from the fiber preform.

### SUMMARY

The present disclosure addresses those problems with a method of manufacturing the ARF via laser welding of the components. By manipulating the welding emission to form a beam waist positioned away from the interface between the components to be welded, a laser weld volume that robustly fuses the components can be formed.

According to a first aspect of the present disclosure, a laser welded glass article comprises: (a) a first glass component comprising an inward primary surface and an outward primary surface; (b) a second glass component fused to the first glass component, the second glass component comprising an inward primary surface and an outward primary surface, the inward primary surface of the second glass component facing the inward primary surface of the first glass component; and (c) a laser weld volume fusing the first glass component and the second glass component together, the weld volume comprising an hourglass, vortex, or conical shaped perimeter.

According to a second aspect of the present disclosure, the laser welded glass article of the first aspect is presented, wherein (i) the inward primary surface of the first glass component is substantially convex, and (ii) the inward primary surface of the second glass component is substantially planar.

According to a third aspect of the present disclosure, the laser welded glass article of the first aspect is presented, wherein (i) the inward primary surface of the first glass component is substantially convex, and (ii) the inward primary surface of the second glass component is substantially concave.

According to a fourth aspect of the present disclosure, the laser welded glass article of the first aspect is presented, wherein (i) the inward primary surface of the first glass component is substantially convex, and (ii) the inward primary surface of the second glass component is substantially convex.

According to a fifth aspect of the present disclosure, the laser welded glass article of any one of the first through fourth aspects is presented, wherein the laser weld volume defines a central void extending at least partially through the laser weld volume.

According to a sixth aspect of the present disclosure, the laser welded glass article of any one of the first through fifth aspects is presented, wherein the laser weld volume terminates in a point and has a substantially vortex shape.

According to a seventh aspect of the present disclosure, the laser welded glass article of any one of the first through sixth aspects is presented, wherein (i) the laser weld volume is substantially symmetrical about a weld axis, and (ii) the weld axis is not orthogonal to the inward primary surface of the second glass component.

According to an eighth aspect of the present disclosure, the laser welded glass article of the seventh aspect is presented, wherein the laser weld volume comprises a weld length along the weld axis within a range of from 0.5 mm to 12.0 mm.

According to a ninth aspect of the present disclosure, a fiber preform comprises: (a) a first preform end, a second preform end, and a longitudinal axis extending from the first preform end to the second preform end; (b) an outer preform cladding through which the fiber longitudinal axis extends, the outer preform cladding comprising an inner cladding surface facing and disposed radially around the longitudinal axis; (c) inner preform tubes coupled to the outer preform cladding at the inner cladding surface of the outer preform cladding, each of the inner preform tubes comprising (i) a tube axis extending therethrough parallel to the longitudinal axis of the fiber preform, (ii) an inner tube surface extending radially around the tube axis, and (iii) an outer tube surface facing away from the tube axis, and wherein the inner preform tubes collectively define a preform core that extends radially from the longitudinal axis and is tangential to the outer tube surface of each of the inner preform tubes; and (d) first laser weld volumes, each of the first laser weld volumes fusing a different one of the inner preform tubes to the outer preform cladding, wherein, each of the first laser weld volumes comprises an hourglass, vortex, or conical perimeter.

According to a tenth aspect of the present disclosure, the fiber preform of the ninth aspect is presented, wherein (i) the outer preform cladding further comprises a cladding thickness that is within a range of from 3 mm to 40 mm, and (ii) each of the inner preform tubes comprise a tube thickness that is within a range of from 0.5 mm to 2 mm.

According to an eleventh aspect of the present disclosure, the fiber preform of any one of the ninth through tenth aspects further comprises nested preform capillaries, each of the nested preform capillaries disposed within a different one of the inner preform tubes, and each of the nested preform capillaries comprising (i) a capillary axis extending therethrough parallel to the tube axis of the inner preform tube within which the nested preform capillary is disposed, (ii) an inner capillary surface extending radially around the capillary axis, and (iii) an outer capillary surface facing away from the capillary axis, wherein, each of third laser weld volumes fuse a different one of the nested preform capillaries to the inner preform tube within which the nested preform capillary is disposed, each of the third laser weld volumes comprising an hourglass, vortex, or conical perimeter.

According to a twelfth aspect of the present disclosure, the fiber preform of the eleventh aspect is presented, wherein the third laser weld volumes overlap the first laser weld volumes.

According to a thirteenth aspect of the present disclosure, the fiber preform of any one of the eleventh through twelfth aspects is presented, wherein each of the nested preform capillaries further comprises a first aperture.

According to a fourteenth aspect of the present disclosure, the fiber preform of the thirteenth aspect is presented, wherein each of nested preform capillaries further comprises a second aperture.

According to a fifteenth aspect of the present disclosure, the fiber preform of any one of the ninth through fourteenth aspects is presented, wherein the first laser weld volumes are proximate the first preform end.

According to a sixteenth aspect of the present disclosure, the fiber preform of the fifteenth aspect further comprises additional first laser weld volumes, each of the additional first laser weld volumes fusing a different one of the inner preform tubes to the outer preform cladding proximate the first preform end inward of the first laser weld volume disposed closest thereto.

According to a seventeenth aspect of the present disclosure, the fiber preform of any one of the ninth through sixteenth aspects is presented, wherein each of the first laser weld volumes comprises a central void extending at least partially therethrough.

According to an eighteenth aspect of the present disclosure, the fiber preform of the seventeenth aspect is presented, wherein the central void terminates in a point within the first laser weld volume, the first laser weld volume taking a substantially vortex shape.

According to a nineteenth aspect of the present disclosure, the fiber preform of any one of the ninth through eighteenth aspect is presented, wherein (i) each of the first laser weld volumes is substantially symmetrical about a weld axis, and (ii) the weld axis is not orthogonal to the longitudinal axis of the fiber preform.

According to a twentieth aspect of the present disclosure, the fiber preform of any one of the ninth through nineteenth aspects is presented, wherein the outer preform cladding and each of the inner preform tubes comprise one or more of silica, doped silica, fluorine-doped borosilicate glass, borosilicate glass, soda-lime glass, and aluminosilicate glass.

According to a twenty-first aspect of the present disclosure, the fiber preform of any one of the ninth through twentieth aspects further comprises second laser weld volumes, each of the second laser weld volumes fusing a different one of the inner preform tubes to the outer preform cladding, wherein, each of the second laser weld volumes comprises an hourglass, vortex, or conical perimeter.

According to a twenty-second aspect of the present disclosure, the fiber preform of the twenty-first aspect is presented, wherein the first laser weld volumes are proximate the first preform end and the second laser weld volumes are proximate the second preform end.

According to a twenty-third aspect of the present disclosure, the fiber preform of the twenty-second aspect further comprises: (a) additional first laser weld volumes, each of the additional first laser weld volumes fusing a different one of the inner preform tubes to the outer preform cladding proximate the first preform end inward of the first laser weld volume disposed closest thereto; and (b) additional second laser weld volumes, each of the additional second laser weld volumes fusing a different one of the inner preform tubes to the outer preform cladding proximate the second preform end inward of the second laser weld volume disposed closest thereto.

According to a twenty-fourth aspect of the present disclosure, the fiber preform of any one of the twenty-first through twenty-third aspects further comprises: nested preform capillaries, each of the nested preform capillaries disposed within a different one of the inner preform tubes, and each of the nested preform capillaries comprising (i) a capillary axis extending therethrough parallel to the tube axis of the inner preform tube within which the nested preform capillary is disposed, (ii) an inner capillary surface extending radially around the capillary axis, and (iii) an outer capillary surface facing away from the capillary axis; wherein (i) each of third laser weld volumes fuses a different one of the nested preform capillaries to the inner preform tube within which the nested preform capillary is disposed, each of the third laser weld volumes proximate the first preform end and comprising an hourglass, vortex, or conical perimeter, and (ii) each of fourth laser weld volumes fuses a different one of the nested preform capillaries to the inner preform tube within which the nested preform capillary is disposed, each of the fourth laser weld volumes proximate the second preform end and comprising an hourglass, vortex, or conical perimeter.

According to a twenty-fifth aspect of the present disclosure, the fiber preform of the twenty-fourth aspect is presented, wherein the third laser weld volumes overlap the first laser weld volumes and the fourth laser weld volumes overlap the second laser weld volumes.

According to a twenty-sixth aspect of the present disclosure, a method of manufacturing a laser welded glass article comprises: (a) a workpiece positioning step comprising positioning a glass workpiece in an intended beam path of a welding emission from a laser, the glass workpiece comprising multiple glass components including at least a first glass component and a second glass component, the first glass component positioned to encounter the welding emission along the intended beam path before the second glass component, and (b) a laser welding step comprising causing the laser to emit the welding emission along the intended beam path, wherein (i) the welding emission converges to a beam waist, (ii) the welding emission causes one or both of the first glass component or the second glass component to increase in temperature and to decrease in viscosity so as to flow and fuse the first glass component and the second glass component together throughout a laser weld volume, and (iii) the beam waist is not coextensive with the laser weld volume.

According to a twenty-seventh aspect of the present disclosure, the method of the twenty-sixth aspect is presented, wherein the welding emission diverges from the beam waist before impinging upon the first component.

According to a twenty-eighth aspect of the present disclosure, the method of any one of the twenty-sixth through twenty-seventh aspects is presented, wherein the beam waist is disposed within the second glass component.

According to a twenty-ninth aspect of the present disclosure, the method of any one of the twenty-sixth through twenty-eighth aspects is presented, wherein (i) before the laser welding step, a gap separates the first glass component and the second glass component along the intended beam path, and (ii) after the laser welding step, the laser weld volume at least partially fills the gap.

According to a thirtieth aspect of the present disclosure, the method of any one of the twenty-sixth through twenty-ninth aspects is presented, wherein the workpiece is substantially free of filler material disposed between the first component and the second component proximate the intended beam path.

According to a thirty-first aspect of the present disclosure, the method of any one of the twenty-sixth through thirtieth aspects is presented, wherein during the workpiece positioning step, the workpiece and the intended beam path are positioned relative to each other so that the intended beam path is not orthogonal to an inward primary surface of the second glass component.

According to a thirty-second aspect of the present disclosure, the method of any one of the twenty-sixth through thirty-first aspects is presented, wherein (i) the multiple glass components of the glass workpiece further includes a third glass component, the third component positioned to encounter the welding emission along the intended beam path, and (ii) the welding emission causes one or more of the first glass component, the second glass component, and the third glass combination to increase in temperature and to decrease in viscosity so as to flow and fuse the first glass component, the second glass component, and the third glass component together throughout the laser weld volume.

According to a thirty-third aspect of the present disclosure, the method of the thirty-second aspect is presented, wherein during the laser welding step, the welding emission forms an aperture through the third component.

According to a thirty-fourth aspect of the present disclosure, the method of any one of the twenty-sixth through thirty-third aspects further comprises: at least one repeat performance of the workpiece positioning step and the laser welding step to fuse the first glass component and the second glass component together throughout an additional laser weld volume that is proximate the laser weld volume.

According to a thirty-fifth aspect of the present disclosure, the method of any one of the twenty-sixth through thirty-fourth aspects is presented, wherein (i) the first glass component is an inner preform tube, (ii) the second glass component is an outer preform cladding, and (iii) the workpiece positioning step and the laser welding step are performed sufficient times to form a fiber preform comprising the inner preform tube and the outer preform cladding fused together at both a first preform end and a second preform end with at least one laser weld volume.

According to a thirty-sixth aspect of the present disclosure, the method of any one of the twenty-sixth through thirty-fifth aspects is presented, wherein the laser is a CO₂ laser.

According to a thirty-seventh aspect of the present disclosure, the method of any one of the twenty-sixth through thirty-sixth aspects is presented, wherein the welding emission is a Gaussian beam or a flat-top beam.

According to a thirty-eighth aspect of the present disclosure, the method of any one of the twenty-sixth through thirty-seventh aspects is presented, wherein the welding emission has a wavelength of peak intensity that is within an infrared range of from 5 µm to 11 µm.

According to a thirty-ninth aspect of the present disclosure, the method of any one of the twenty-sixth through thirty-eighth aspects is presented, wherein (i) the laser emits the welding emission with a power within a range of from 15 W to 500 W, and (ii) the laser emits the welding emission as pulses over a time period within a range of from 3 second to 20 seconds.

According to a fortieth aspect of the present disclosure, the method of any one of the twenty-sixth through thirty-ninth aspects is presented, wherein the laser emits the welding emission with a power sufficient to enable thermal lensing of the weld emission in one or both of the first glass component or the second glass component.

According to a forty-first aspect of the present disclosure, the method of the fortieth aspect is presented, wherein (i) the beam waist is positioned along the intended beam path between the laser and the first glass component, and (ii) the thermal lensing of the weld emission occurs in the first glass component.

According to a forty-second aspect of the present disclosure, the method of any one of the fortieth through forty-first aspects is presented, wherein the thermal lensing of the weld emission produces the laser weld volume.

According to a forty-third aspect of the present disclosure, the method of any one of the fortieth through forty-second aspects is presented, wherein the power of the welding emission is insufficient to induce non-linear effects in either the first glass component or the second glass component.

According to a forty-fourth aspect of the present disclosure, an anti-resonant hollow core optical fiber drawn from the fiber preform of any one of ninth through twenty-fifth aspects or from a fiber preform made pursuant to the method of the thirty-fifth aspect.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

### In the Drawings

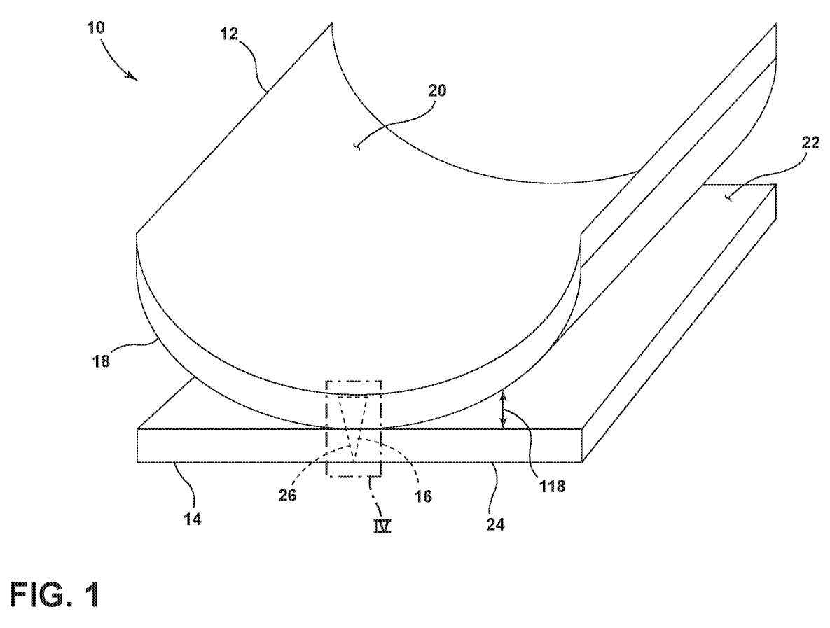

FIG. 1 is a perspective view of a laser welded glass article of the present disclosure, illustrating a laser weld volume fusing a first glass component and a second glass component together, with the first glass component having an inward primary surface that is convex and the second glass component having an inward primary surface that is flat;

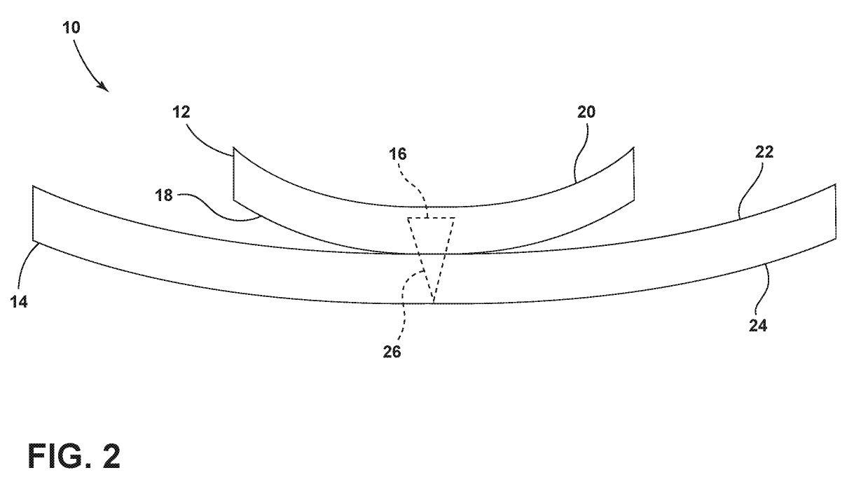

FIG. 2 is an elevation view of another embodiment of the laser welded glass article, illustrating the inward primary surface of the first glass component being convex and the inward primary surface of the second glass surface being concave;

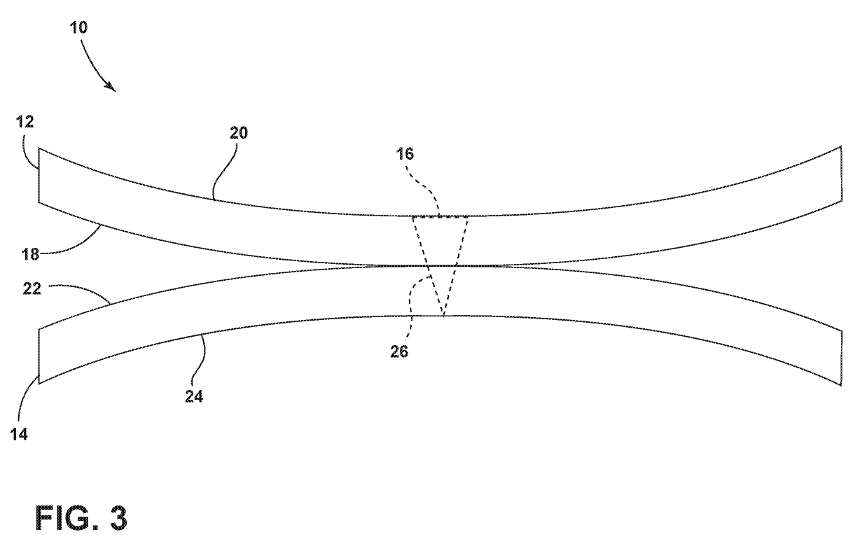

FIG. 3 is an elevation view of another embodiment of the laser welded glass article, illustrating the inward primary surface of the first glass component being convex and the inward primary surface of the second glass surface being convex as well;

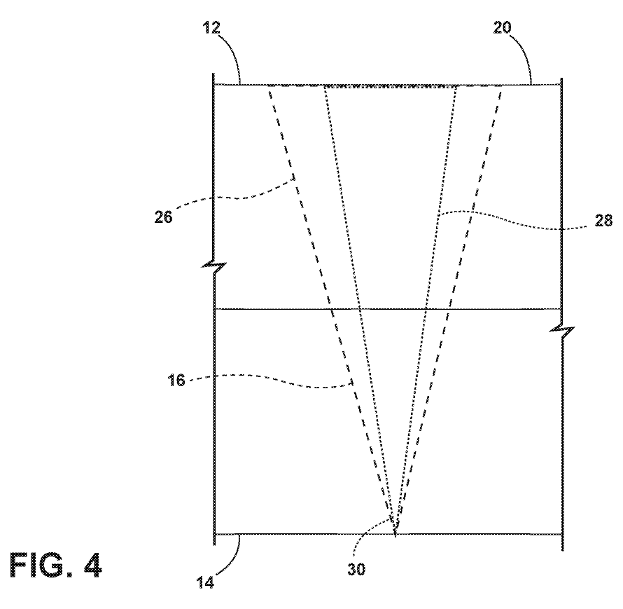

FIG. 4 is a magnified elevation view of area IV of FIG. 1, illustrating the laser weld volume having a perimeter with a characteristic shape, here a vortex with a perimeter and a central void extending therethrough to a point;

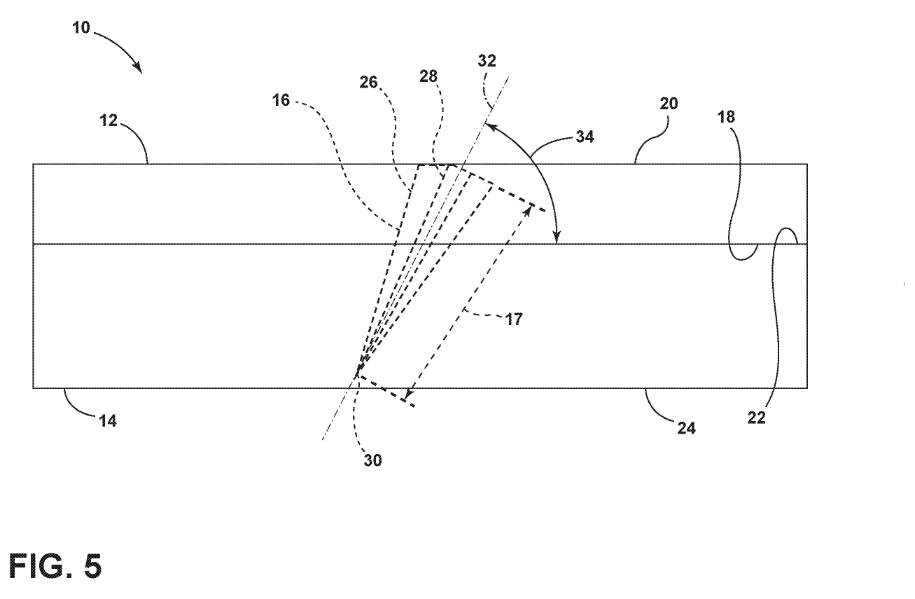

FIG. 5 is an elevation view of another embodiment of the laser welded glass article, illustrating the laser weld volume having a weld axis that forms an acute angle relative to the inward primary surfaces of the first glass component and the second glass component;

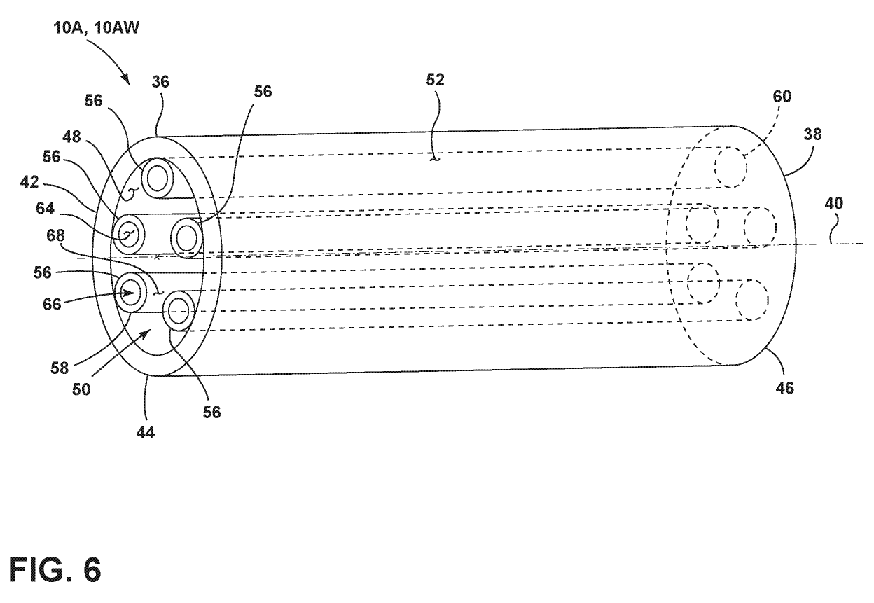

FIG. 6 is a perspective view of a fiber preform (as an example of the laser welded glass article), illustrating an outer preform cladding with a cladding interior and inner preform tubes disposed within the cladding interior;

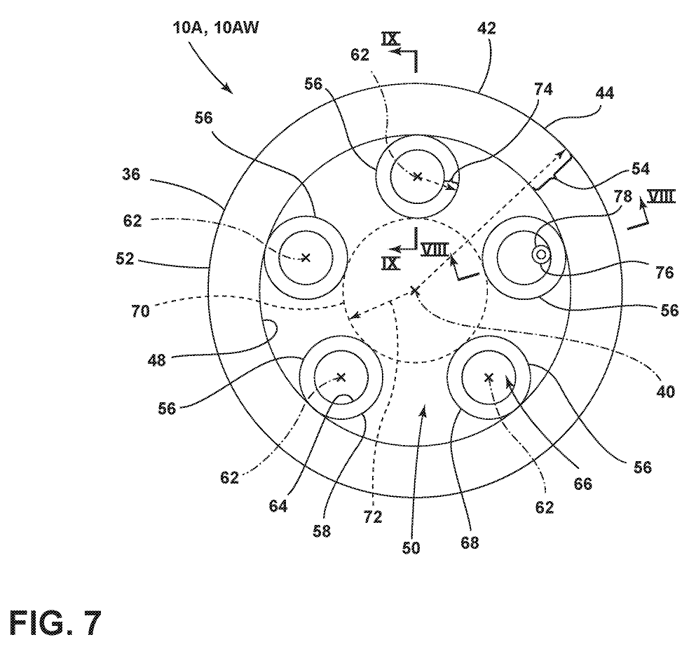

FIG. 7 is an elevation view of the fiber preform from a first preform end thereof, illustrating outer tube surfaces of the inner preform tubes defining a preform core;

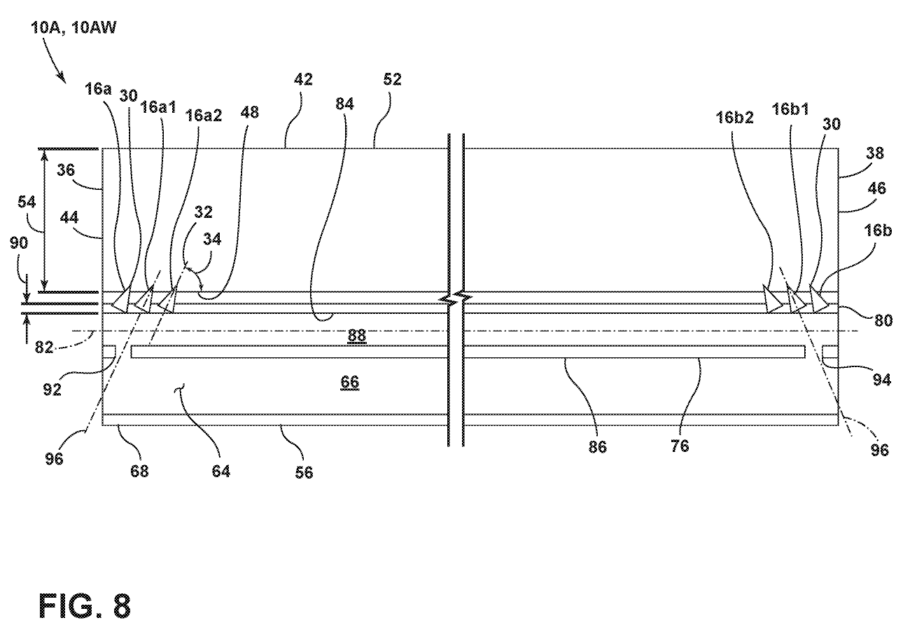

FIG. 8 is an elevation view of a cross-section of an embodiment of the fiber preform taken through line VIII-VIII of FIG. 7 that further includes preform capillaries within the inner preform tubes, illustrating a first laser weld volume welding a preform capillary, one of the inner preform tubes, and the outer preform cladding together at the first preform end and a second laser weld volume welding those components together at a second preform end;

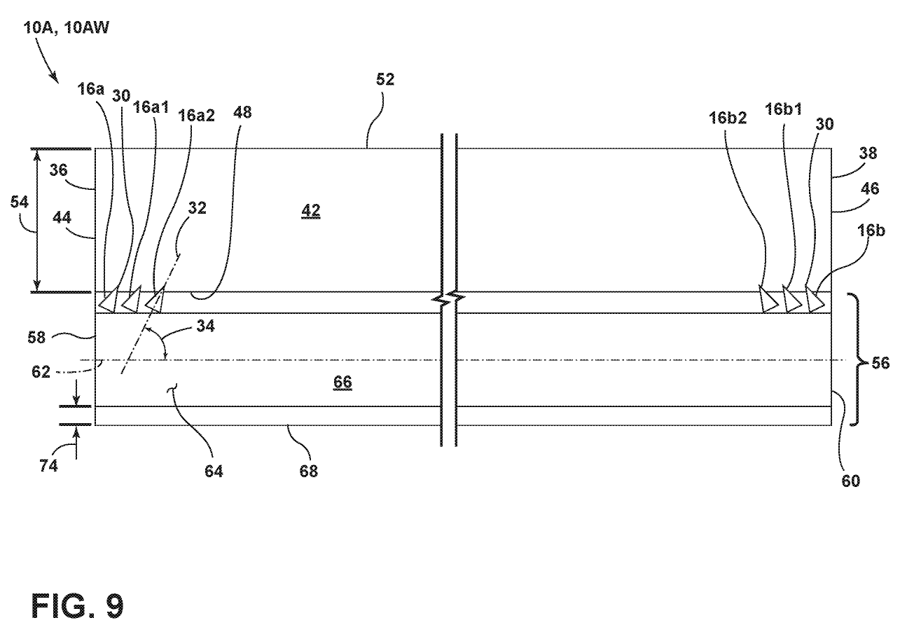

FIG. 9 is an elevation view of a cross-section of the fiber preform taken through line IX-IX of FIG. 7, illustrating the first laser weld volume fusing one of the inner preform tubes and the outer preform cladding together at the first preform end and the second laser weld volume welding those components together at the second preform end;

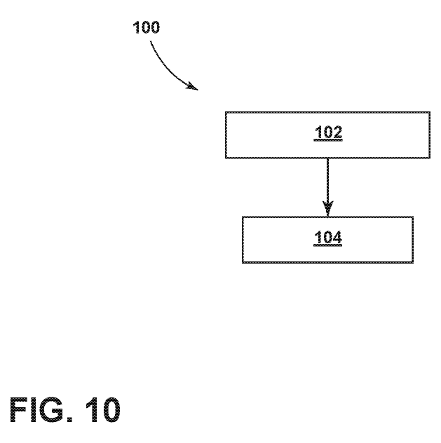

FIG. 10 is a schematic diagram of a method of manufacturing the laser welded glass article, illustrating a workpiece positioning step and a laser welding step;

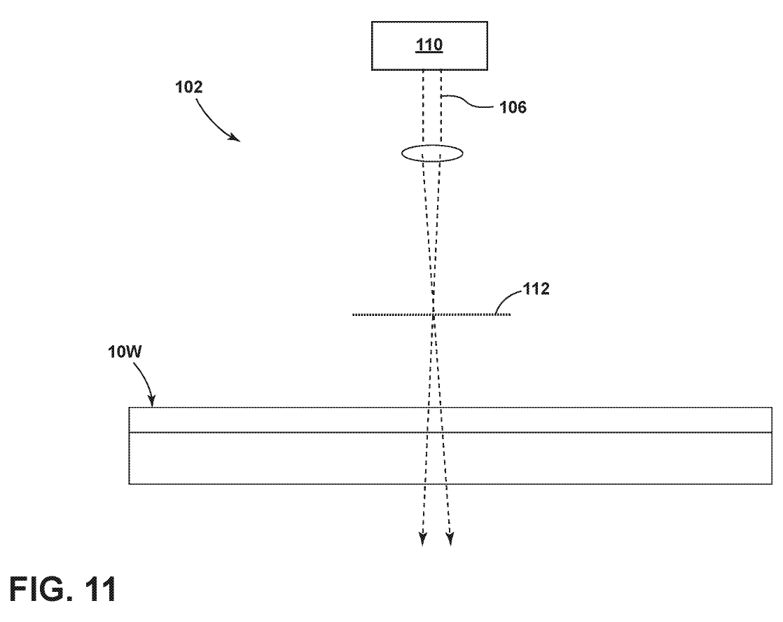

FIG. 11 is an elevation view of an embodiment of the workpiece position step, illustrating a glass workpiece with a first glass component and a second glass component to be fused at an interface therebetween being positioned within an intended beam path from a laser;

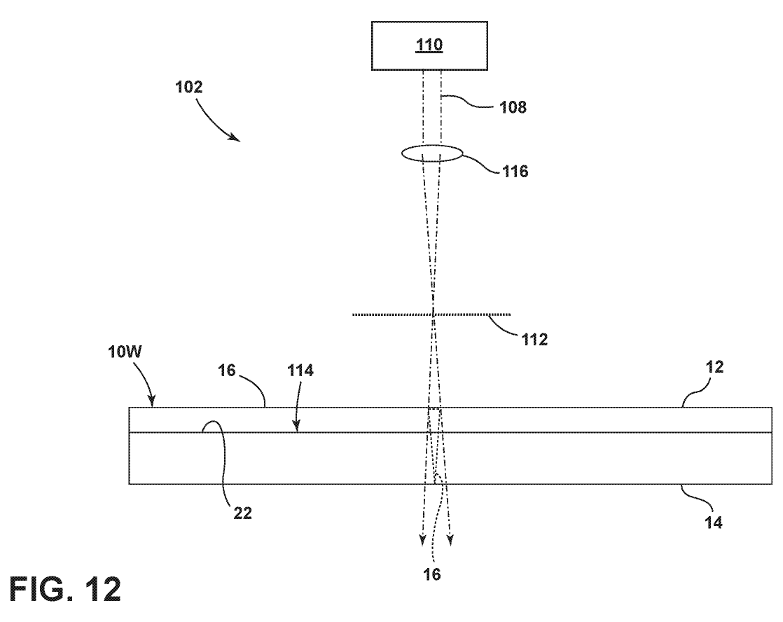

FIG. 12 is an elevation view of an embodiment of the laser welding step as a continuation of FIG. 11, illustrating the laser emitting a welding emission along the intended beam path from FIG. 11 with a beam waist that precedes the outward primary surface of the first glass component but nevertheless causing the formation of the laser weld volume that extends into both the first glass component and the second glass component;

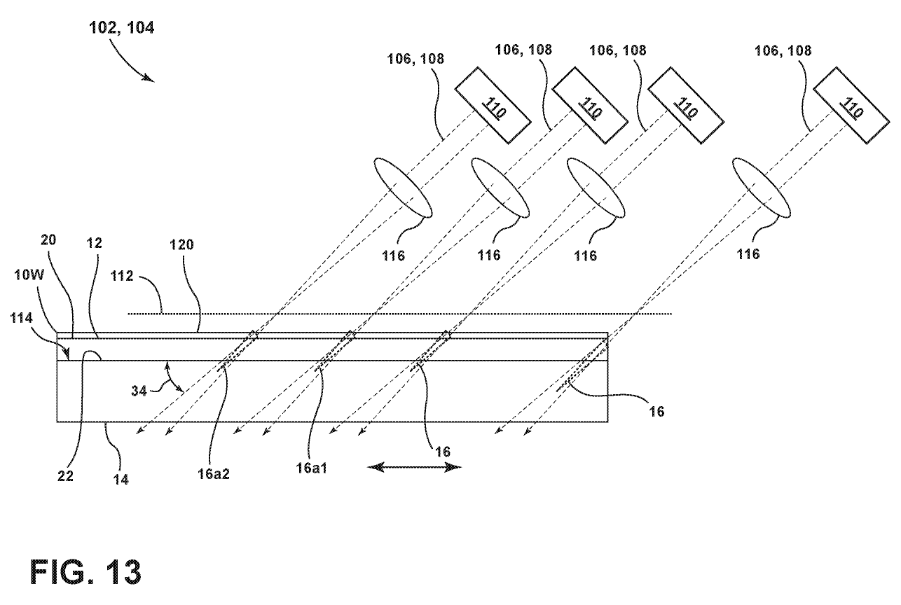

FIG. 13 is an elevation view of another embodiment of the method, illustrating the weld emission entering the glass workpiece, which now includes a third glass component, at an acute angle relative to the interfaces between the glass components to be fused, as well as the glass workpiece being translated for subsequent performances of the laser welding step to form additional laser weld volumes;

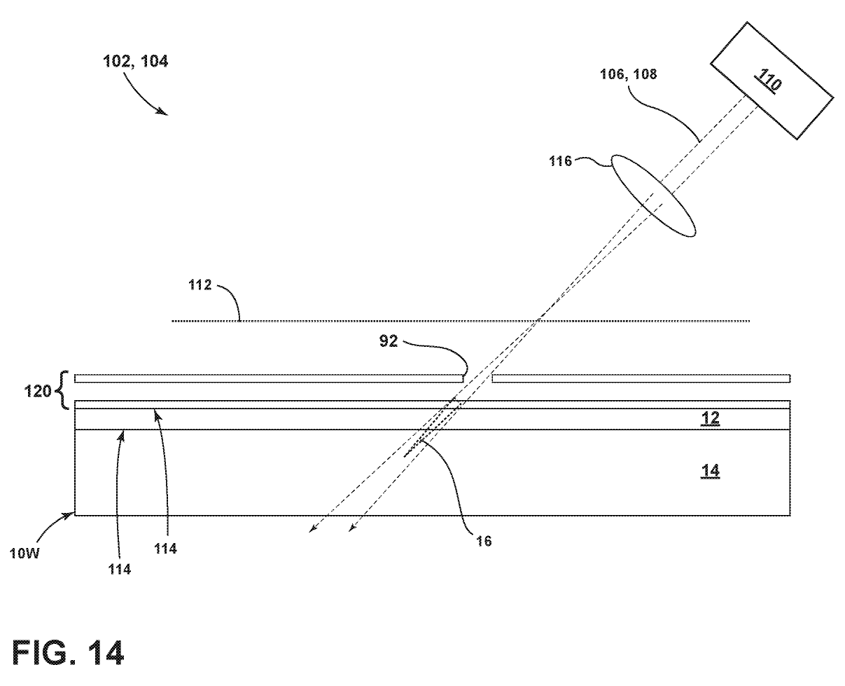

FIG. 14 is an elevation view of another embodiment of the method, illustrating the third glass component of the glass workpiece being a capillary or something else with an air channel and the welding emission forming an aperture through the portion of the third component closest to the laser and then subsequently forming the laser weld volume to fuse the components;

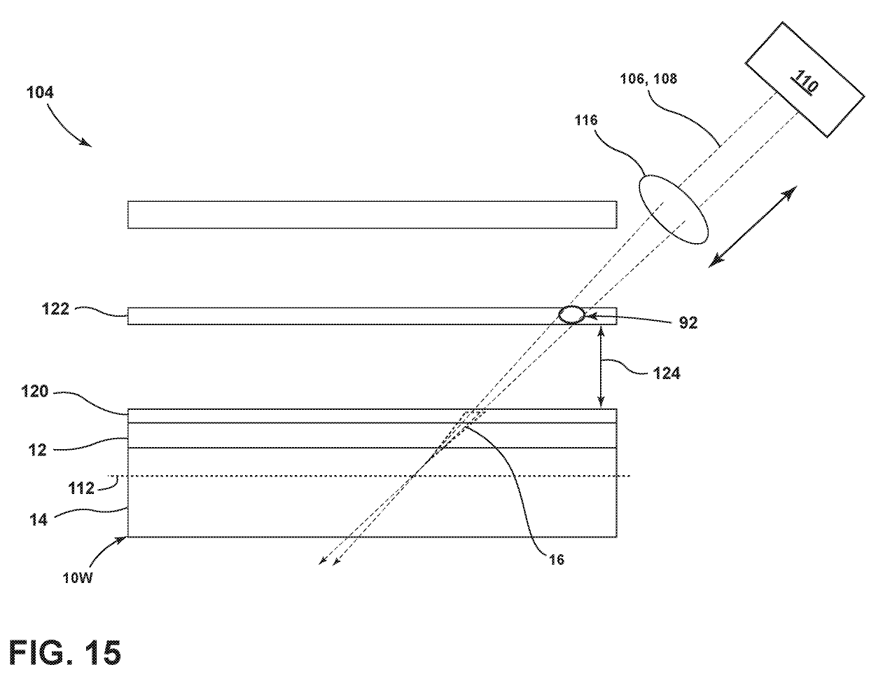

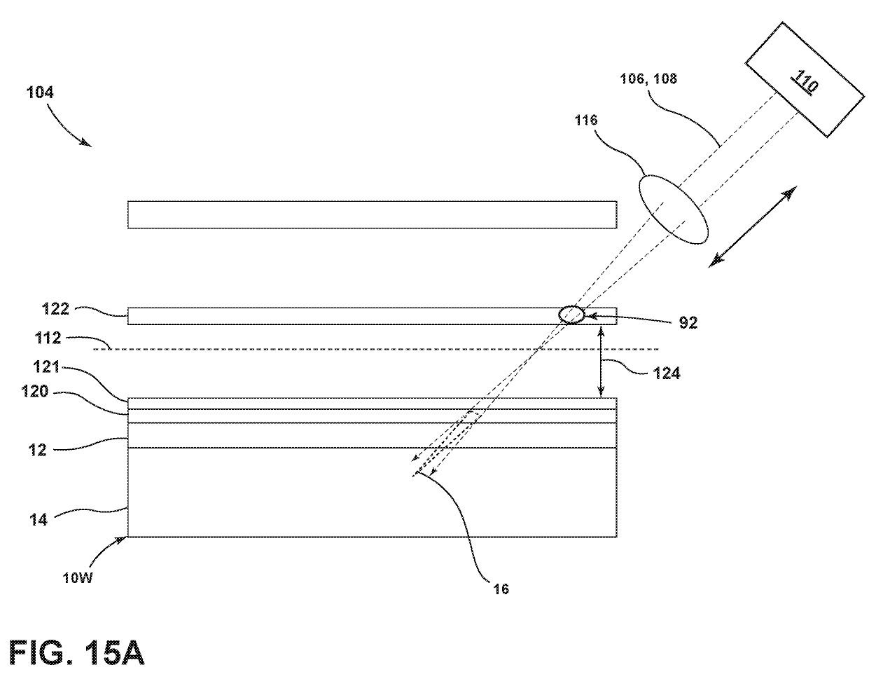

FIG. 15 is similar to FIG. 14 but includes a fourth glass component (instead of a hollow third glass component) separated from the other glass components by an air gap and shows the beam waist within the thickness of the second glass component below all of the interfaces between the glass components;

FIG. 15A is similar to FIG. 15 but includes a four layered glass components into which the welding emission causes a laser weld volume to form to fuse all four layers together, as would be the case in a double nested arrangement;

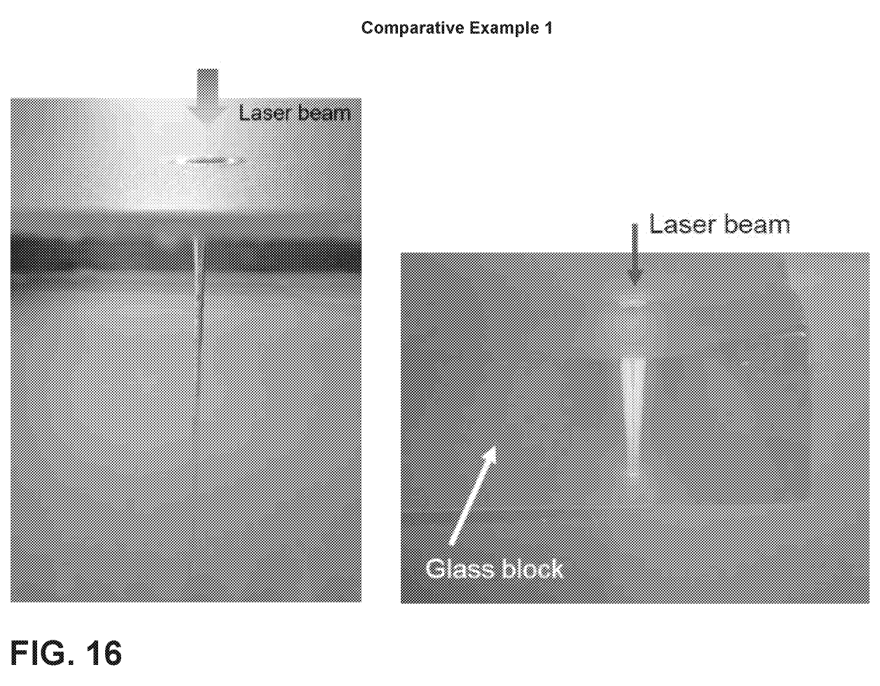

FIG. 16, pertaining to Comparative Example 1, are images of a filament that a laser emission formed into the glass component when the beam waist of the emission was coincident with the top primary surface of the glass component;

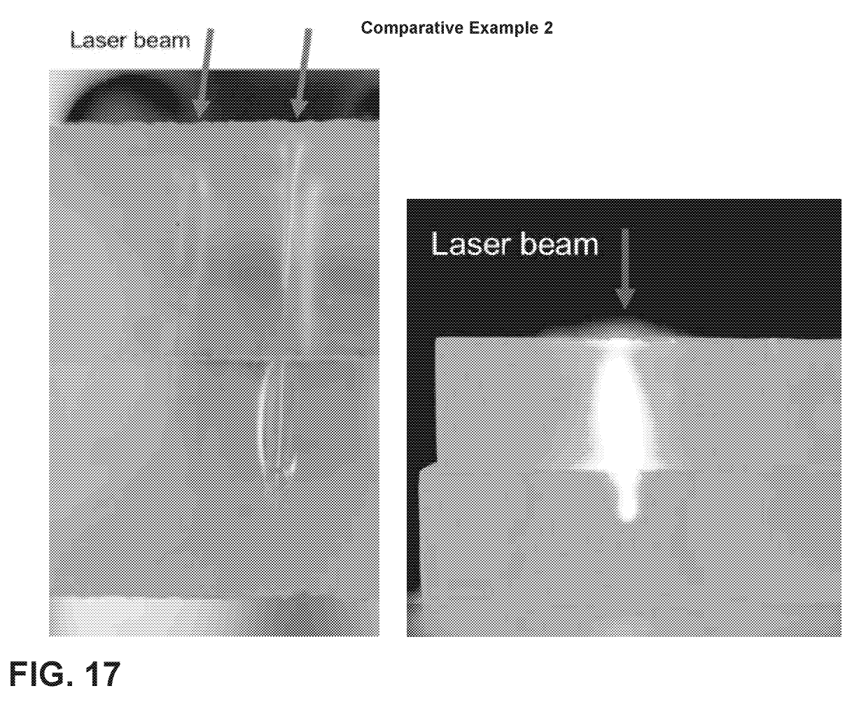

FIG. 17, pertaining to Comparative Example 2, are images of a filament that an attempted welding emission formed through the two layered glass components without resulting in fusion of the two components and cracking the bottom component;

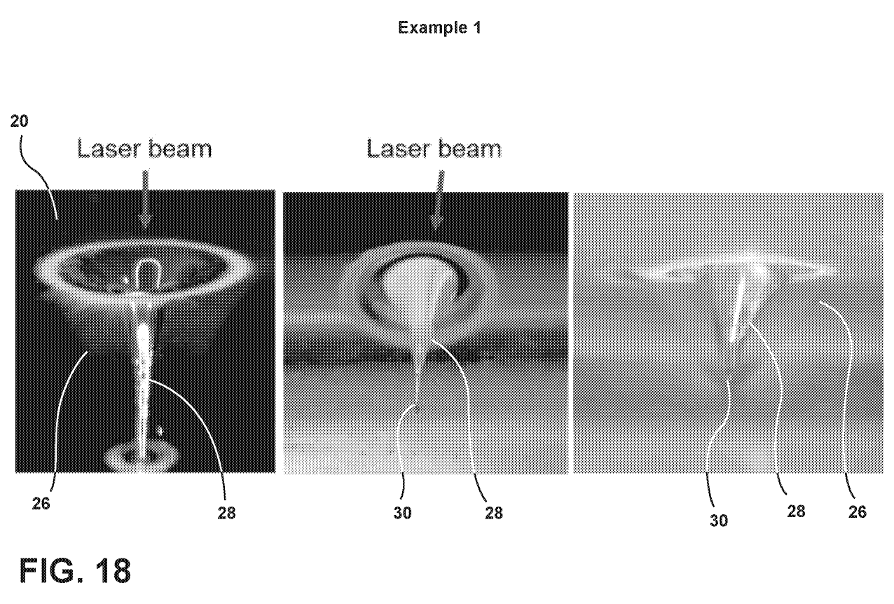

FIG. 18, pertaining to Example 1, are images of melted volume within a glass component resulting from a laser emission with the beam waist preceding the top surface of the glass component, illustrating a characteristic vortex shaped perimeter with a central void extending to a point within the glass material;

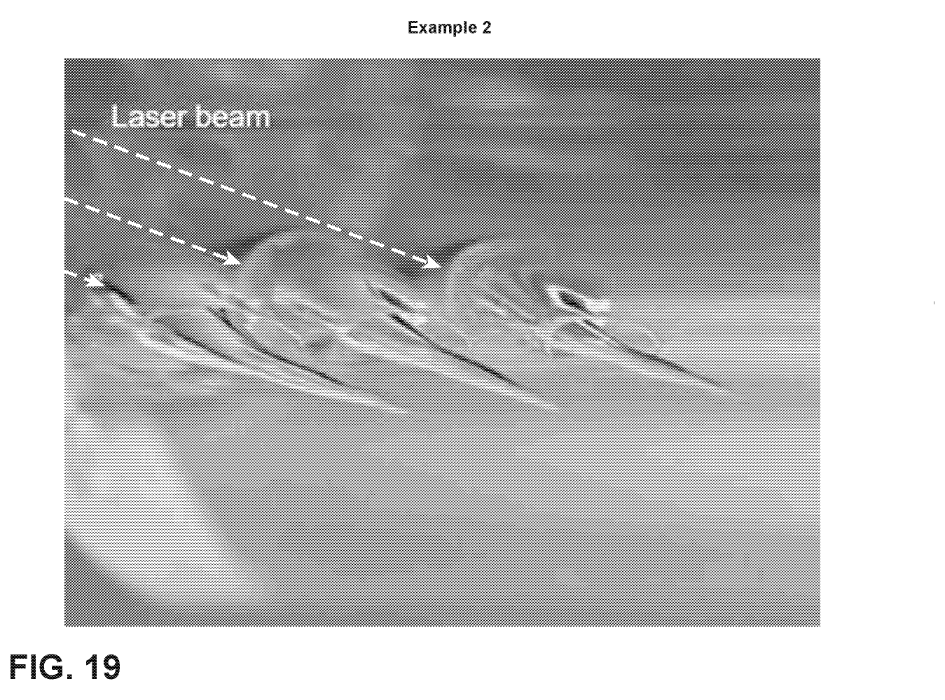

FIG. 19, pertaining to Example 2, are images similar to those of Example 1 but showing a triple of such vortex shaped perimeters resulting from three laser emissions in sequence (with translation of the glass between each emission) and additionally showing the perimeters having an axis at an angle relative to the surface of the glass;

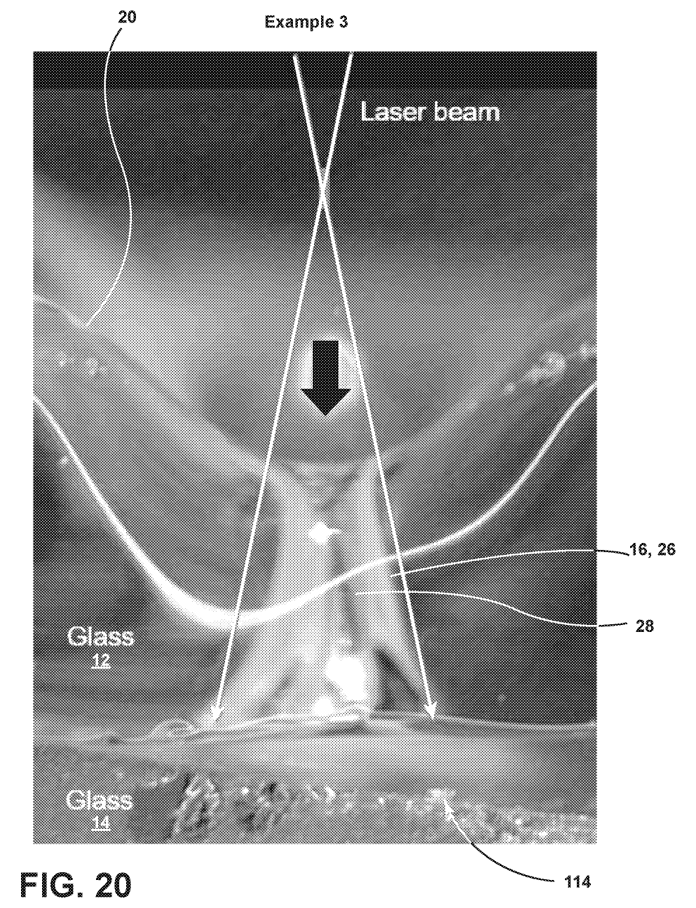

FIG. 20, pertaining to Example 3, is an image of a laser weld volume fusing two glass components, illustrating the laser welded volume having a perimeter with a characteristic hourglass shape and additionally including a central void;

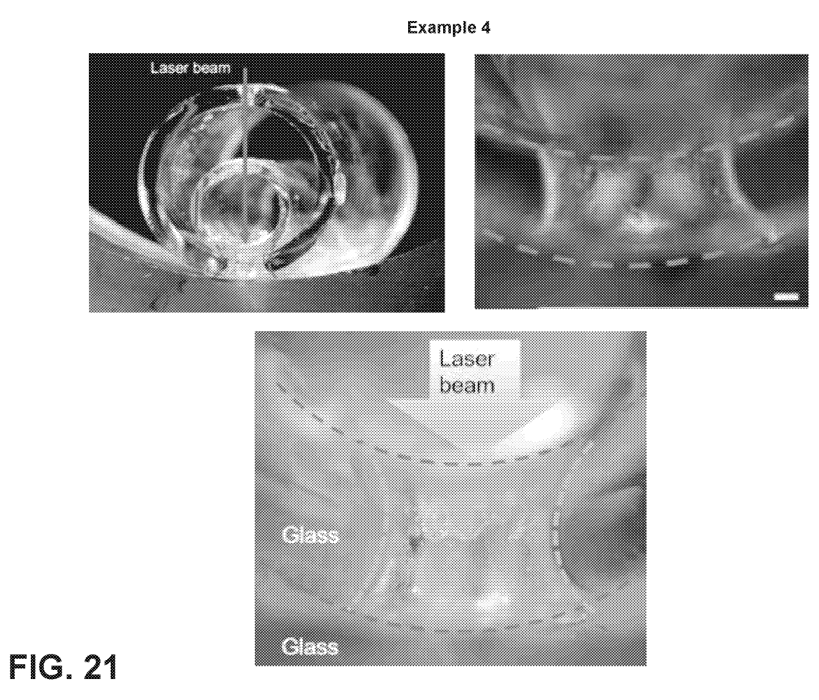

FIG. 21, pertaining to Example 4, are images of a laser weld volume with a perimeter having a characteristic hourglass shape fusing a preform capillary, an inner preform tube, and a preform cladding together;

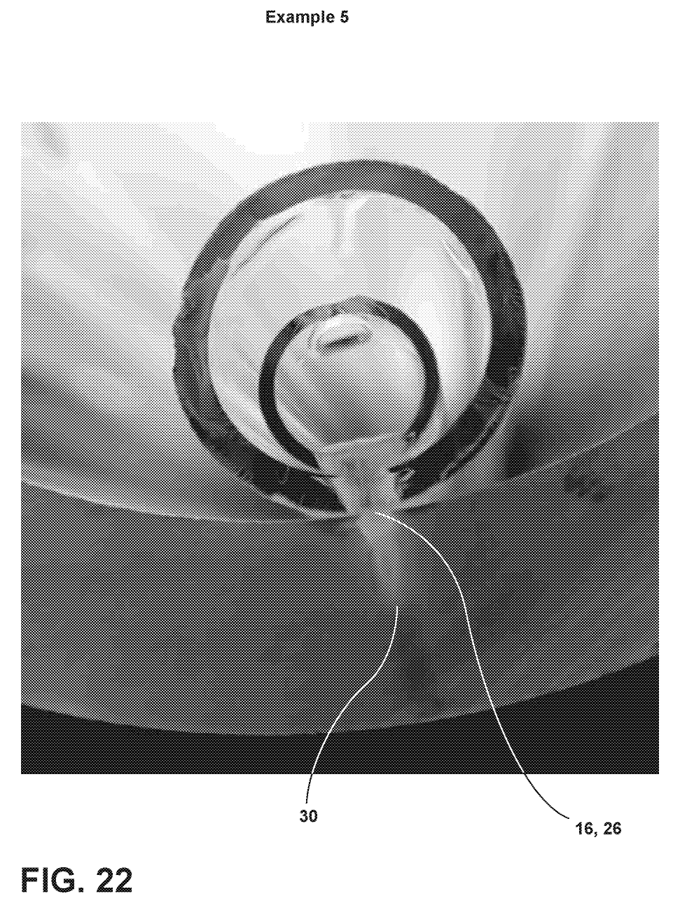

FIG. 22, pertaining to Example 5, is an image of a laser weld volume with a perimeter having a characteristic conical shape fusing a preform capillary, an inner preform tube, and a preform cladding together, and additionally an aperture through the preform capillary that the welding emission formed; and

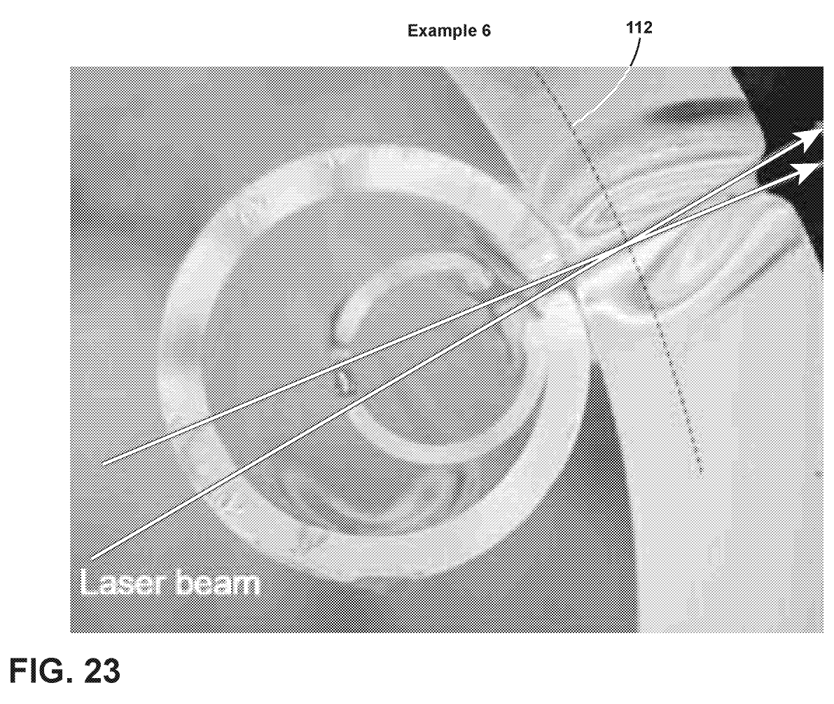

FIG. 23, pertaining to Example 6, is an image of a welding emission having fused a preform capillary, an inner preform tube, and a preform cladding together while the beam waist was disposed within the cladding thickness.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Referring to FIGS. 1-3, a laser welded glass article 10 is herein described. The laser welded glass article 10 includes a first glass component 12 and a second glass component 14. The first glass component 12 and the second glass component 14 are fused to each other at a laser weld volume 16. The first glass component 12 includes an inward primary surface 18 and an outward primary surface 20, which may face in generally opposite directions. Likewise, the second glass component 14 includes an inward primary surface 22 and an outward primary surface 24, which may face in generally opposite directions. The inward primary surface 18 of the first glass component 12 and the inward primary surface 22 of the second glass component 14 are “inward” in the sense that they face each other – the inward primary surface 18 of the first glass component 12 faces the inward primary surface 22 of the second glass component 14. The laser weld volume 16 fuses the first glass component 12 and the second glass component 14 together.

The first glass component 12 and the second glass component 14 can take any form and shape. For example, the first glass component 12 and the second glass component 14 can be tubes, sheets, or combination of the two. In embodiments, proximate the laser weld volume 16, the inward primary surface 18 of the first glass component 12 is substantially convex, while the inward primary surface 22 of the second glass component 14 is substantially planar (see FIG. 1). In other embodiments, proximate the laser weld volume 16, the inward primary surface 18 of the first glass component 12 is substantially convex, while the inward primary surface 22 of the second glass component 14 is substantially concave (see FIG. 2). In other embodiments, proximate the laser weld volume 16, the inward primary surface 18 of the first glass component 12 and the inward primary surface 22 of the second glass component 14 are both is substantially convex (see FIG. 3).

Referring now to FIG. 4, because of the way that the laser weld volume 16 is formed (discussed below), the laser weld volume 16 can take one of several characteristic shapes. In embodiments, the laser weld volume 16 has a perimeter 26 that is substantially an hourglass, conical, or vortex shape. In some instances, the laser weld volume 16 defines a central void 28 that extends at least partially through the laser weld volume 16. The central void 28 may be open at the outward primary surface 20 of the first glass component 12. The central void 28 can terminate in a point 30 and, in such instances, the perimeter 26 of the laser weld volume 16 can have a substantially vortex or conical shape.

Referring now to FIG. 5, in embodiments, the laser weld volume 16 extends characteristically relative to the inward primary surface 22 of the second glass component 14. For example, the laser weld volume 16 can be substantially symmetric about a weld axis 32. In such instances, the weld axis 32 is not orthogonal to inward primary surface 22 of the second glass component 14. Rather, the weld axis 32 forms an acute angle 34 relative to the inward primary surface 22 of the second glass component 14. The laser weld volume 16 has a weld length 17 along the weld axis 32. In embodiments, the weld length 17 is within a range of from 0.5 mm to 12.0 mm. For example, the weld length 17 can be 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, 10.0 mm, 10.5 mm, 11.0 mm, 11.5 mm, 12.0 mm, or within any range bound by any two of those values (e.g., from 1.0 to 10.0 mm, from 5.5 mm to 7.5 mm, and so on).

Referring now to FIGS. 6-9, while the laser welded glass article 10 can be anything, the laser welded glass article 10 can advantageously be a fiber preform 10A. The fiber preform 10A includes a first preform end 36 and a second preform end 38. The first preform end 36 and the second preform end 38 face in opposite directions. The fiber preform 10A further includes a longitudinal axis 40 that extends from the first preform end 36 to the second preform end 38.

The fiber preform 10A further includes an outer preform cladding 42. The outer preform cladding 42 can be considered to be an embodiment of the second glass component 14 of the laser welded glass article 10. The longitudinal axis 40 extends through the outer preform cladding 42. The outer preform cladding 42 has a first cladding end 44 that may define at least in part the first preform end 36. The outer preform cladding 42 has a second cladding end 46 that may define at least in part the second preform end 38. The outer preform cladding 42 provides an inner cladding surface 48 that is disposed radially around the longitudinal axis 40. The inner cladding surface 48 is analogous to the inward primary surface 22 of the second glass component 14. The inner cladding surface 48 faces the longitudinal axis 40. The inner cladding surface 48 defines a cladding interior 50 through which the longitudinal axis 40 extends. The inner cladding surface 48 can at least partially define the longitudinal axis 40 of the fiber preform 10A. The outer preform cladding 42 further includes an outer cladding surface 52 that faces away from the longitudinal axis 40. The outer preform cladding 42 further includes a cladding thickness 54 (see now FIG. 7) that is measured radially relative to the longitudinal axis 40 between the inner cladding surface 48 and the outer cladding surface 52. In embodiments, the cladding thickness 54 is within a range of from 3 mm to 40 mm. For example, the cladding thickness 54 can be 3 mm, 5 mm, 7 mm, 10 mm, 15 mm, 20 mm, 25 mm, 30 mm, 35 mm, 40 mm, or within any range bound by any two of those values (e.g., from 5 mm to 15 mm, from 15 mm to 30 mm, and so on). The cladding thickness 54 could be less than 3 mm or greater than 40 mm, however – the provided values are just exemplary.

The fiber preform 10A further includes inner preform tubes 56. Each of the inner preform tubes 56 can be considered to be an embodiment of the first glass component 12 of the laser welded glass article 10. The inner preform tubes 56 are at least partially disposed within the cladding interior 50 of the outer preform cladding 42. As will be discussed in greater detail herein, inner preform tubes 56 are coupled to the outer preform cladding 42 at the inner cladding surface 48. Each of the inner preform tubes 56 has a first tube end 58 that may define at least in part the first preform end 36. Each of the inner preform tubes 56 has a second tube end 60 that may define at least in part the second preform end 38. Each of the inner preform tubes 56 has a tube axis 62 extending therethrough that is parallel to the longitudinal axis 40 of the fiber preform 10A. Each of the inner preform tubes 56 provides an inner tube surface 64 that is disposed radially around the tube axis 62 thereof. The inner tube surface 64 defines a tube interior 66 through which the tube axis 62 extends. Each of the inner preform tubes 56 provides an outer tube surface 68 that faces away from the tube axis 62 thereof. The outer tube surface 68 is analogous to the inward primary surface 18 of the first glass component 12. The inner tube surface 64 and the outer tube surface 68 of each of the inner preform tubes 56 can extend from the tube axis 62 thereof at constant radiuses (not separately illustrated). The inner preform tubes 56 collectively define a preform core 70. The preform core 70 extends radially around the longitudinal axis 40 at a core radius 72. The preform core 70 is tangential to the outer tube surface 68 of each of the inner preform tubes 56. The inner preform tubes 56 may be equidistantly spaced from each other.

Each of the inner preform tubes 56 has a tube thickness 74, which may all be the same. The tube thickness 74 is measured radially relative to the tube axis 62 between the inner tube surface 64 and the outer tube surface 68. In embodiments, the cladding thickness 54 is greater than the tube thickness 74. In embodiments, the tube thickness 74 is within a range of from 0.5 mm to 2.0 mm. For example, the tube thickness 74 can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or within any range bound by any two of those values (e.g., from 0.7 mm to 1.5 mm, from 0.8 mm to 1.6 mm, and so on). The tube thickness 74 can be less than 0.5 mm or greater than 2.0 mm, however – those values are merely exemplary.

In embodiments, the fiber preform 10A further includes nested preform capillaries 76 (see FIGS. 7-8). The nested preform capillaries 76 are disposed within the inner preform tubes 56. More particularly, each of the nested preform capillaries 76 is disposed within the tube interior 66 of a different one of the inner preform tubes 56. Such an arrangement is sometimes referred to as a nested arrangement. Each of the nested preform capillaries 76 has a first capillary end 78 that may define at least in part the first preform end 36. Each of the nested preform capillaries 76 has a second capillary end 80 that may define at least in part the second preform end 38 of the fiber preform 10A. Each of the nested preform capillaries 76 includes a capillary axis 82 extending therethrough. The capillary axis 82 is parallel to the longitudinal axis 40 of the fiber preform 10A and thus the tube axis 62. Each of the nested preform capillaries 76 further includes an inner capillary surface 84 and an outer capillary surface 86. The inner capillary surface 84 extends radially around the capillary axis 82 and defines a capillary channel 88, such as at a constant radius (not separately illustrated) from the capillary axis 82. The outer capillary surface 86 faces away from the tube axis 62, such as at a constant radius (not separately illustrated) from the capillary axis 82. Each of the nested preform capillaries 76 has a capillary thickness 90, which may all be the same. The capillary thickness 90 is measured radially relative to the tube axis 62 between the inner capillary surface 84 and the outer capillary surface 86 of the nested preform capillary 76. In embodiments, the capillary thickness 90 capillary is within 10% of the tube thickness 74 of the inner preform tube 56, and may be equal to the tube thickness 74 to the extent achievable under manufacturing tolerances.

The fiber preform 10A further includes first laser weld volumes 16a and optionally second laser weld volumes 16b (see FIGS. 8 and 9), each of which are an example of the laser weld volume 16 discussed above in connection with the laser welded glass article 10. Each of the first laser weld volumes 16a fuse a different one of the inner preform tubes 56 to the outer preform cladding 42 proximate the first preform end 36. Similarly, each of the second laser weld volumes 16b fuses a different one of the inner preform tubes 56 to the outer preform cladding 42 proximate the second preform end 38. In embodiments of the fiber preform 10A that include the nested preform capillaries 76, each of the first laser weld volumes 16a preferably further fuses a different one of the nested preform capillaries 76 to the inner preform tube 56 within which the nested preform capillary 76 is disposed proximate the first preform end 36. Similarly, each of the second laser weld volumes 16b preferably further fuses a different one of the nested preform capillaries 76 to the inner preform tube 56 within which the nested preform capillary 76 is disposed proximate the second preform end 38.

In embodiments, the first laser weld volumes 16a are located at positions away from, or not proximate to, first preform end 36 and the second laser weld volumes 16b are located at positions away from, or not proximate to, second preform end 38.

In embodiments, the fiber preform 10A further includes additional first laser weld volumes 16a₁, 16a₂, . . . 16aₙ and additional second laser weld volumes 16b₁, 16b₂, . . . 16bₙ to enhance the welding of the inner preform tubes 56 and the outer preform cladding 42 together. In embodiments, each of the additional first laser weld volumes 16a₁, 16a₂, . . . 16aₙ fuses a different one of the inner preform tubes 56 to the outer preform cladding 42 proximate the first preform end 36 inward of the first laser weld volume 16a closest thereto. For example, the first laser weld volume 16a is disposed closest to the first preform end 36 of the fiber preform 10A, the additional first laser weld volume 16a₁ is disposed inward longitudinally along the longitudinal axis 40 from the first laser weld volume 16a, and the additional first laser weld volume 16a₂ is disposed inward longitudinally along the longitudinal axis 40 from the additional first laser weld volume 16a₁. The first laser weld volume 16a and the additional first laser weld volumes 16a₁, 16a₂, . . . 16aₙ may thus collectively form weld doublets, weld triplets (as illustrated), and so on, fusing each of the inner preform tubes 56 to the outer preform cladding 42.

In embodiments, each of the additional second laser weld volumes 16b₁, 16b₂, . . . 16bₙ weld a different one of the inner preform tubes 56 to the outer preform cladding 42 proximate the second preform end 38 inward of the second laser weld volume 16b closest thereto. For example, the second weld laser volume 16b is disposed closest to the second preform end 38, the additional second laser weld volume 16b₁ is disposed inward longitudinally along the longitudinal axis 40 from the second laser weld volume 16, and the additional second laser weld volume 16b₂ is disposed inward longitudinally along the longitudinal axis 40 from the additional second laser weld volume 16b₁. The second laser weld volume 16b and the additional second laser weld volumes 16b₁, 16b₂, . . . 16bₙ may thus collectively form weld doublets, weld triplets (as illustrated), and so on welding each of the inner preform tubes 56 to the outer preform cladding 42 at the second preform end 38.

As examples of the laser weld volume 16, each of the first laser weld volumes 16a, the additional first laser weld volumes 16a₁, 16a₂, . . . 16aₙ, the second laser weld volumes 16b, and the additional second laser weld volumes 16b₁, 16b₂, . . . 16bₙ have the perimeter 26 with the characteristic shape, such as an hourglass, vortex, or conical shape. The discussion above for the laser weld volume 16 applies equally as well to each of the first laser weld volumes 16a, the additional first laser weld volumes 16a₁, 16a₂, . . . 16aₙ, the second laser weld volumes 16b, and the additional second laser weld volumes 16b₁, 16b₂, . . . 16bₙ. In embodiments where each of the first laser weld volumes 16a, the additional first laser weld volumes 16a₁, 16a₂, . . . 16aₙ, the second laser weld volumes 16b, and the additional second laser weld volumes 16b₁, 16b₂, . . . 16bₙ are substantially symmetrical about their respective weld axis 32, the weld axis 32 is not orthogonal to the longitudinal axis 40 of the fiber preform 10A. Rather the weld axis 32 is at the acute angle 34 relative to the longitudinal axis 40 and the tube axis 62, which are parallel to the inner cladding surface 48. Adjacent laser weld volumes 16 can be separated or can partially overlap.

In embodiments of the fiber preform 10A that further include the nested preform capillaries 76 (see FIG. 8), each of the nested preform capillaries 76 can have a first aperture 92 and a second aperture 94. The first aperture 92 is disposed proximate the first preform end 36. The second aperture 94 is disposed proximate the second preform end 38. The first aperture 92 and the second aperture 94 are consequence of the way that first laser weld volumes 16a and the second laser weld volumes 16b can be formed, respectively, as further discussed below. Each of the first apertures 92 is aligned with a different one of the first laser weld volumes 16a. For example, a straight line 96 extends from outside of the fiber preform 10A, through the first aperture 92, and into the first laser weld volume 16a. Similarly, each of the second apertures 94 is aligned with a different one of the second laser weld volumes 16b.

As mentioned, the laser welded glass article 10 includes the first glass component 12 and the second glass component 14. As each of the inner preform tubes 56 are considered to be embodiments of the first glass component 12 in the context of the fiber preform 10A as the laser welded glass article 10, each of the inner preform tubes 56 comprise glass. Similarly, as the outer preform cladding 42 is considered to be an embodiment of the second glass component 14 in the same context, the outer preform cladding 42 comprises a glass composition. Examples of suitable glass compositions include one or more of silica, doped silica, fluorine-doped borosilicate glass, borosilicate glass, soda-lime glass, and aluminosilicate glass.

Referring now to FIGS. 10-15, a method 100 of manufacturing the laser welded glass article 10, such as the fiber preform 10A, is herein described. The method 100 includes a workpiece positioning step 102 and a laser welding step 104. The method 100 can further include one or more other steps.

The workpiece positioning step 102 (see FIG. 11) includes positioning a glass workpiece 10W in an intended beam path 106 of a welding emission 108 (see FIG. 12) from a laser 110. The glass workpiece 10W is the predecessor to the laser welded glass article 10. The glass workpiece 10W is thus identical to the laser welded glass article 10, except that the glass workpiece 10W lacks the laser weld volumes 16. In the context of the fiber preform 10A, the glass workpiece 10W can be considered to be a fiber preform workpiece 10AW that is identical for relevant present purposes to the fiber preform 10A except for the lack of the first laser weld volumes 16a and the second laser weld volumes 16b. In any event, for workpiece positioning step 102, the first glass component 12 (e.g., one of the inner preform tubes 56) is positioned to encounter the welding emission 108 along the intended beam path 106 before the second glass component 14 (e.g., the outer preform cladding 42).

The laser welding step 104 (see FIG. 12) includes causing the laser 110 to emit the welding emission 108 along the intended beam path 106. The welding emission 108 in turn causes material of one or both of the first glass component 12 and the second glass component 14 to increase in temperature, decrease in viscosity, to flow, and upon cooling of the material to fuse the first glass component 12 and the second glass component 14 together at the laser weld volume 16. In short, the laser welding step 104 forms the laser weld volume 16 that fuses the first glass component 12 and the second glass component 14 together. In one embodiment, material of the first glass component 12 and material of the second glass component 14 intermix before cooling to fuse at the laser weld volume 16.

The laser 110 is configured so that the welding emission 108 converges to a beam waist 112. The beam waist 112 corresponds to the minimum cross-sectional area of the welding emission 108. As welding emission 108 approaches the beam waist 112, it converges and reduces in cross-sectional area. As the welding emission 108 continues beyond beam waist 112 it diverges and increases in cross-sectional area. Unlike previous attempts at laser welding, the beam waist 112 is not coextensive with the laser weld volume 16, the outward primary surface 16 of the first glass component 12, or the inward primary surface 22 of the second glass component 14 (and thus not at an interface 114 between the first glass component 12 and the second glass component 14). The beam waist 112 instead occurs along the intended beam path 106 of the welding emission 108 either before or after the laser weld volume 16 but not therewithin so that the beam waist 112 and laser weld volume 16 are spaced apart and not overlapping. Accordingly, the welding emission 108 that forms laser weld volumes 16 is diverging at interface 114 and produces laser weld volumes 16 with an hourglass, conical, or vortex perimeter as described and demonstrated herein.

In embodiments, the beam waist 112 occurs along the intended beam path 106 of the welding emission 108 before where the welding emission 108 would form the laser weld volume 16. That is, the beam waist 112 is positioned along the intended beam path 106 between the laser weld volume 16 and the laser 110 such as between outward primary surface 16 of the first glass component 12 and the laser 110. For example, the welding emission 108 begins diverging from the beam waist 112 before impinging upon the outward primary surface 16 of the first glass component 12.

The energy from the welding emission 108 is conveyed to where the laser weld volume 16 forms via a thermally induced beam lensing effect. The thermal lensing is induced by changes in the glass refractive index due to thermal gradients and laser-induced stress patterns. Thermal lensing of the welding emission 108 occurs within the glass materials essentially where the laser weld volume 16 forms. The irradiance level of the laser 110 is set well below the threshold that could cause non-linear effects such as catastrophic self-focusing and laser-induced breakdown. This is primarily achieved by using focusing optics 116 for the welding emission 108 that position the beam waist 112 "above" or "in front of" the outward primary surface 20 of the first glass component 12 (e.g., the inner tube surface 64 of the inner preform tube 56). In other words, the method 100 utilizes a welding emission 108 that diverges as the most preferred option, which prevents the increase in irradiance with propagation distance, thereby avoiding catastrophic self-focusing. It was experimentally confirmed that manipulating the welding emission 108 to diverge from the beam waist 112 before encountering the outward primary surface 20 of the first glass component 12 prevents the increase in irradiance with propagation distance arising from non-linear effects in the first glass component 12, thereby avoiding catastrophic self-focusing and generation of high residual stress. Not only does the welding emission 108 generate a robust laser weld volume 16 but the volume of material impacted by glass melting is relatively low and thus stress around the laser weld volume 16 is relatively low as well. By controlling the position of beam waist 112 relative to interface 114 and the power (or power density) of welding emission 108, it is possible to selectively confine and localize the region of glass melting in close proximity to interface 114 to avoid deleterious collateral heating effects away from laser weld volume 16 that are known to occur when beam waist 112 is coextensive with interface 114 or laser weld volume 16. Stronger fusing of first glass component 12 and second glass component 14 results with reduced residual stress within and in the material surrounding laser weld volume 16.

In other embodiments, the beam waist 112 occurs along the intended beam path 106 of the welding emission 108 after where the welding emission 108 would form the laser weld volume 16. As an example, the beam waist 112 is disposed within the second glass component 14 and the laser 110 is configured so that the welding emission 108 would converge until beam waist 112 and then diverge thereafter. So placing the beam waist 112 can be useful when the first glass component 12 and/or the second glass component 14 (or some other glass component of the glass workpiece 10W) is particularly thick. In this scenario, an increased power density in the focal area results in the formation of a convergent-divergent vortex-shaped melted volume. The increased power density could induce excessive stress potentially leading to localized cracking. However, the potential for cracking can be mitigated by using focusing optics 116 with a focal length that is relatively long to increase the area of the beam waist 112. In addition, the power density can be reduced, while still maintaining the power density high enough to form the laser weld volume 16, such as by increasing the welding period of time. That compromise gradually increases the temperature within the glass volume and eventually leads to melting and formation of the laser weld volume 16.

So configuring the laser 110 has advantageous consequences. For example, before the laser welding step 104, a gap 118 (refer back to FIG. 1) can separate the first glass component 12 and the second glass component 14 proximate the intended beam path 106. The gap 118 exists in embodiments where the inward primary surface 18 of the first glass component 12 does not substantially match the second glass component 14 in terms of contour, such as when the outer tube surface 68 of the inner preform tube 56 has a radius that is smaller than a radius of the inner cladding surface 48 of the outer preform cladding. The outer tube surface 68 of the inner preform tube 56 and the inner cladding surface 48 of the outer preform cladding 42 touch at a line parallel to the longitudinal axis 40, and that is where the laser weld volume 16 would be formed, but the gap 118 exists to either side of that line. Configuring the laser 110 so that the beam waist 112 is not coextensive with the line where those components touch results in a laser weld volume 16 that at least partially fills the gap 118. So configuring the laser 110 restricts the welding emission 108 from generating a filament within the glass components (e.g., the inner preform tube 56 and the outer preform cladding 42) and instead forms a wider vortex-shaped volume of melted glass material, which can penetrate through the thickness of the glass components. When reaching the interface 114 between the first glass component 12 and the second glass component 14, the vortex-shaped molten volume driven by energy from the welding emission 108 expands and can create the laser weld volume 16, which is relatively large and provides strong fusing. Stated another way, because of the divergence of welding emission 108 from the beam waist 112 before encountering the first glass component 12, and the elliptical shape of the welding emission 108, the heat-affected area at interface 114 between the first glass component 12 and the second glass component 14 can be relatively large and the melted volume expands through the thickness of the first glass component 12 (e.g., the tube thickness 74) towards the interface 114, thereby welding together not only the area of direct contact of the first glass component 12 and the second glass component 14 but additionally filling the gap 118 around the area of direct contact, which increases weld strength. At the same time due to the thermal lensing of the laser energy the melted zone extends further into the glass towards the next interface 114 enabling fusion of several glass layers.

As a related further consequence, the glass workpiece 10W (e.g., the fiber preform workpiece 10AW) can be substantially free of filler material disposed between the first component (e.g., the inner preform tube 56) and the second component (e.g., the outer preform cladding 42) proximate the intended beam path 106. Prior techniques of laser welding have included filler material between the glass components to broaden out the welded volume between the glass components. However, that is not necessary with the method 100.

Referring now to FIG. 13, as mentioned above, the weld axis 32 can be other than orthogonal to the inward primary surface 22 of the second glass component 14. One way to achieve that is in connection with the workpiece positioning step 102. In embodiments, during the workpiece positioning step 102, the glass workpiece 10W and the intended beam path 106 are positioned relative to each other so that the intended beam path 106 is not orthogonal to an inward primary surface 22 of the second glass component 14. The laser 110 and the glass workpiece 10W are positioned so that the intended beam path 106 is at the acute angle 34 relative to the inward primary surface 22 of the second glass component 14 (see also FIG. 5). As discussed above, the manipulating focusing optics 116 so that the beam waist 112 is disposed preceding the outward primary surface 20 of the first glass component 12 (and the glass workpiece 10W generally) along the intended beam path 106 resists the welding emission 108 producing a filament but rather facilitates the welding emission 108 to form a molten glass volume that extends through the interface 114 between the first glass component 12 and the second glass component 14. Further expansion of the molten glass volume through or along the interface 114, which increases the size of the laser weld volume 16 and thus strength of the fusion, is facilitated by placing the intended beam path 106 at the acute angle 34. Forming the laser weld volume 16 along the acute angle 34 can generate the perimeter 26 of the laser weld volume 16 as vortex shaped or hourglass shaped, which experiments have shown to be particularly strong.

While the first glass component 12 and the second glass component 14 of the glass workpiece 10W have been mentioned thus far, in embodiments, the multiple glass components of the glass workpiece 10W further includes a third glass component 120 (still FIG. 13). In the context of the fiber preform workpiece 10AW as the glass workpiece 10W, each of the nested preform capillaries 76 are analogous to the third glass component 120. During the workpiece positioning step 102, the third glass component 120 is likewise positioned to encounter the welding emission 108 along the intended beam path 106. During the laser welding step 104, the welding emission 108 causes one or more of the first glass component 12, the second glass component 14, and the third glass combination to increase in temperature and to decrease in viscosity so as to flow and fuse the first glass component 12, the second glass component 14, and the third glass component 120 together throughout the laser weld volume 16. Alternatively, the welding emission 108 can cause separate laser weld volumes 16 to form – one of the laser weld volumes 16 to fuse the first glass component 12 and the second glass component 14, and another of the laser weld volumes 16 to fuse the third glass component 120 to whichever of the first glass component 12 and the second glass component 14 is closest to the third glass component 120. In some embodiments, the laser weld volume 16 that fuses first glass component 12 and the second glass component 14 and the laser weld volume 16 that fuses second glass component 14 and the third glass component 120 overlap. The third glass component 120 (e.g., the nested preform capillary 76) can be positioned to be encountered by the welding emission 108 before the first glass component 12 (e.g., the inner preform tube 56) and the second glass component 14 (e.g., the outer preform cladding 42) but need not be.

In instances where the third glass component 120 is a capillary (e.g., the nested preform capillary 76), during the laser welding step 104, the welding emission 108 forms the first aperture 92 (see FIG. 14) through the third glass component 120 before impinging upon the third glass component 120 again to form laser weld volume 16. In other instances, a fourth glass component 122 (see FIG. 15) could be disposed in the intended beam path 106 before the third glass component 120 and separated from the third glass component 120 by an air gap 124. By positioning the beam waist 112 before the fourth glass component 122, the welding emission 108 can form the aperture 92 through the fourth glass component 122 and place the laser weld volume(s) 16 to fuse the first glass component 12, the second glass component 14, and the third glass component 120. The making of the aperture 92 and the formation of the laser weld volume(s) 16 can occurring during a single performance of the laser welding step 104. The beam waist 112 could be positioned within the air gap 124 and doing so may reduce stress within the various components as a result of the laser welding. In other instances (see FIG. 15) a fifth glass component 121 is layered together with the third glass component 120, the first glass component 12, and the second glass component 14 with the air gap 124 separating the fifth glass component 121 from fourth glass component 122. In such instances, and in others as well, the beam waist 122 can be formed within the air gap 124 and the aperture 92 can be formed as a result of the welding emission 108. In addition to the aperture 92, the welding emission 108 forms the laswer weld volume(s) 16 that extends through all four of the layers – the fifth glass component 121, the third glass component 120, the first glass component 12, and the second glass component 14.

Referring back to FIG. 13, in embodiments, the method 100 includes at least one repeat performance of the workpiece positioning step 102 and the laser welding step 104 to fuse the first glass component 12 and the second glass component 14 together throughout an additional laser weld volume 16a₁ that is proximate the laser weld volume 16. Experiments leading to the present disclosure have shown that additional laser weld volume 16 provides increased resistance in response to shearing force. Failure in response to shearing force often occurs at the first glass component 12 rather than at the laser weld volume 16 or additional laser weld volume 16a₁. In the context of the fiber preform workpiece 10AW as the glass workpiece 10W, the at least one repeat performance generates the desired quantity of the additional first laser weld volumes 16a₁, 16a₂, . . . 16aₙ and the additional second laser weld volumes 16b₁, 16b₂, . . . 16bₙ. For example, the intended beam path 106 of the welding emission 108 can be held static and the fiber preform workpiece 10AW can be translated along the longitudinal axis 40 slightly during the repeat performance of the workpiece positioning step 102 so the next performance of the laser welding step 104 forms the additional first laser weld volume 16a₁ just inward of the first laser weld volume 16a. In embodiments, the workpiece positioning step 102 and the laser welding step 104 are performed sufficient times to form the fiber preform 10A with the inner preform tube 56 and the outer preform cladding 42 fused together at both the first preform end 36 and the second preform end 38 with at least one laser weld volume 16.

As mentioned, the laser 110 generates the welding emission 108. The type of laser 110 is not particularly important. However, useful examples include a CO or CO₂ laser. The welding emission 108 can be a Gaussian beam or a flat-top beam, among other possibilities. Use of a Gaussian beam can lead to high weld strength while requiring relatively low power and a welding time period that is relatively short (short exposure times). Use of a flat-top beam can provide a more uniform distribution of laser energy within the glass material and can reduce stress concentration around the laser weld volume 16 that results. As mentioned, the welding emission 108 generates the vortex-shaped volume of molten glass that penetrates through the thickness of the first glass component 12 and into the second glass component 14. How far into the thickness the vortex-shaped volume of molten glass penetrates is a function of several parameters, including positioning of the beam waist 112 relative to the outward primary surface 20, the power of the laser per unit area (power density), and a welding period of time, which is the duration of the exposure to the welding emission 108.

In embodiments, the welding emission 108 from the laser 110 has a wavelength of peak intensity that is within a range of from 5 µm to 11 µm. For example, the wavelength of peak intensity can be 5 µm, 6 µm, 7 µm, 8 µm, 9 µm, 10 µm, 11 µm, or within any range bound by any two of those values (e.g., from 5 µm to 10 µm, from 6 µm to 9 µm, and so on). Silica glasses strongly absorb emissions of such wavelengths. However, the welding emission 108 within such a wavelength range can effectively penetrate substantial glass volumes and multiple glass-glass interfaces 114 with minimal divergence under specific conditions. Those values are not meant to be exhaustive.

In embodiments, the laser 110 emits the welding emission 108 with a power within a range of from 15 W to 500 W. For example, the power for the welding emission 108 can be 15 W, 20 W, 30 W, 40 W, 50 W, 60 W, 70 W, 80 W, 90 W, 100 W, 110 W, 120 W, 130 W, 140 W, 150 W, 160 W, 170 W, 180 W, 190 W, 200 W, 250 W, 300 W, 350 W, 400 W, 450 W, 500 W, or within any range bound by any two of those values (e.g., from 80 W to 170 W, and so on). The power could be less than 15 W or greater than 500 W, however. As a more particular example, for a welding emission 108 having a wavelength of peak intensity of 10.6 µm, the power could be within a range of from 15 to 500 W, preferably within a range of from 100 W to 180 W, and even more preferably within a range of from 120 W to 160 W.

In embodiments, the laser 110 emits the welding emission 108 as pulses over a welding time period within a range of from 3 seconds to 20 seconds. For example, the welding time period can be 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds, 19 seconds, 20 seconds, or within any range bound by any two of those values (e.g., from 11 seconds to 18 seconds, and so on). The welding period of time could be longer than 20 seconds. In embodiments, duration of each pulse is within a range of from 10 µs to 100 µs. For example, the duration of each pulse can be 10 µs, 20 µs, 30 µs, 40 µs, 50 µs, 60 µs, 70 µs, 80 µs, 90 µs, 100 µs, or within any range bound by any two of those values (e.g., from 20 µs to 90 µs, from 40 µs to 80 µs, and so on). In embodiments, the laser 110 emits the pulses with a frequency within a range of from 1 kHz to 100 kHz. For example, the frequency can be 1 kHz, 10 kHz, 20 kHz, 30 kHz, 40 kHz, 50 kHz, 60 kHz, 70 kHz, 80 kHz, 90 kHz, 100 kHz, or within any range bound by any two of those values (e.g., from 1 kHz to 1 kHz, from 1 kHz to 1 kHz, and so on). An example combination of frequency and pulse duration is 10 kHz and 50 µs. The power (beam intensity) and pulse duration in this can be specifically selected to avoid nonlinear effects, such as nonlinear absorption and photoionization.

Focusing optics 116 for the welding emission 108 has been mentioned several times herein. The focusing optics 116 can be a mirror or lens. The focusing optics 116 can have a focal length. In embodiments, the focal length is within a range of from 50 mm to 500 mm. For example, the focal length can be 50 mm, 100 mm, 150 mm, 200 mm, 250 mm, 300 mm, 350 mm, 400 mm, 450 mm, 500 mm, or within any range bound by any two of those values (e.g., from 50 mm to 150 mm, from 200 mm to 400 mm, and so on).

As mentioned, the welding emission 108 can be a Gaussian beam. The welding emission 108 can impinge upon the outward primary surface 20 of the first glass component 12 with an elliptical perimeter. The elliptical perimeter can bound a surface area upon the outward primary having a value with a range of from 1.2 mm² to 25 mm². For example, the surface area can be 1.2 mm², 2.0 mm², 4.0 mm², 6.0 mm², 8.0 mm², 10 mm², 12 mm², 14 mm², 16 mm², 18 mm², 20 mm², or within any range bound by any two of those values (e.g., from 6.0 mm² to 10 mm², from 4.0 mm² to 16 mm², and so on). In embodiments, the welding emission 108 has an average power density within a range of from 10 W/mm² to 30 W/mm². For example, the average power density can be 10 W/mm², 12 W/mm², 14 W/mm², 15 W/mm², 16 W/mm², 18 W/mm², 20 W/mm², 22 W/mm², 24 W/mm², 25 W/mm², 26 W/mm², 28 W/mm², 30 W/mm², or within any range bound by any two of those values (e.g., from 15 W/mm² to 25 W/mm², from 10 W/mm² to 14 W/mm², and so on). As mentioned, the laser weld volumes 16 can be formed as pairs, triplets, and so on to increase bond strength. It is feasible to replace pairs and triplets, and so on, with a single laser weld volume 16. However, the power associated with the welding emission 108 should be increased to maintain the same average power density as the combined welding emissions 108 used to form the doublet, triplet, etc.

An anti-resonant hollow core optical fiber (not separately illustrated) can then be drawn from the fiber preform 10A described here, such as the fiber preform 10A made pursuant to the method 100 of the present disclosure.

The fiber preform 10A and the method 100 of the present disclosure address the problems set forth in Background, in a variety of ways. Among them, the method 100 utilizes a laser 110 instead of an open flame to fuse the inner preform tubes 56 to the outer preform cladding 42. Thus, the level of contamination resulting from the use of an open flame to weld is avoided. In addition, focusing optics 116 along with power of the laser 110 are manipulated to reduce distortion of the inner preform tubes 56 and other glass components of the fiber preform 10A (aside from the distortion necessary to make the laser weld volume 16) relative to the distortion that arises from using an open flame. Placement of the beam waist 112 as described herein to produce laser weld volumes 16 with diverging welding emission 108 improves the strength of fusion and reduces residual stress relative to methods in which the beam waist 112 is coextensive with the laser weld volumes 16.

### Examples

Comparative Example 1 – For Comparative Example 1, a single glass sheet was positioned relative to a laser so that an intended beam path of an emission from the laser would enter orthogonally into the glass sheet relative to a top surface thereof. The glass sheet was made of fused silica and had a thickness within a range of from 8 mm to 10 mm. Focusing optics of the laser were adjusted so that the emission converged to a beam waist coinciding with the top surface of the glass sheet. The laser was then caused to emit the emission.

The emission induced the formation of a small-diameter filament (e.g., void) in the shape of a vortex. The filament terminated in a point. The filament was substantially symmetric about a void axis that was orthogonal to the top surface of the glass sheet. Images of the glass sheet and the resulting filament were captured under non-polarized light (left) and polarized (right). Those images are reproduced at FIG. 16.

Comparative Example 2 – For Comparative Example 2, a glass workpiece of a first glass sheet and a second glass sheet layered over the first glass sheet was positioned relative to a laser so that the intended beam path of the laser would enter the first (top) glass sheet first orthogonally to the outward facing surface of the first glass sheet. Both the first glass sheet and the second glass sheet were made of fused silica. Focusing optics were manipulated so that a welding emission from the laser would converge to a beam waist coinciding with the outward facing surface of the first glass sheet.

The welding emission deeply penetrated the glass workpiece well into the second glass sheet. The welding emission produced a vortex-shaped filament (void) that extended through the first glass sheet, through the interface between the first glass sheet and the second glass sheet, and into the second glass sheet. The filament was symmetric about a void axis that was approximately orthogonal to the outward facing surface of the first glass sheet. However, the welding emission did not create a substantial weld volume between the first glass sheet and the second glass sheet. No strong bond was formed. The welding emission did create a crack within the second glass sheet, presumably because of the generation of excessive stress. Images of the glass workpiece during the welding emission (right) and afterwards (left) were captured and reproduced at FIG. 17.

Example 1 – For Example 1, single glass sheets or tube walls were positioned relative to a laser so that an intended beam path of an emission from the laser would enter orthogonally into each of the glass sheets relative to a top surface thereof. Each of the glass sheets were made of fused silica. Focusing optics of the laser were adjusted so that the emission converged to a beam waist preceding (e.g. above) the top surface of each of the glass sheets relative to the intended beam path. The laser was then caused to emit the emissions. The emissions generated distinct vortex shaped volumes of molten glass. The void of the vortex was well defined, as was a surrounding vortex shaped volume of glass that had been molten and then cooled. The volume within the perimeter 26 could have been at least partially molten. The area within the perimeter 26 was heated at least partially up to softening point then cooled, which caused residual stress and refractive index changes.

The volume of glass as well as the void were symmetric about a void axis orthogonal to the top surface of the glass sheet. Images were captured and reproduced at FIG. 18.

Example 2– For Example 2, a glass workpiece consisting of a glass tube was positioned in an intended beam path of an emission from a laser, with the top surface of the glass tube to encounter the emission first. Focusing optics were manipulated so that the emission would converge to a beam waist before encountering any glass material from the glass workpiece along the intended beam path. The emission would then be in a state of divergence before entering into the glass tube at the top surface thereof. Further, the glass tube and the intended beam path were positioned relative to each other so that the intended beam path was not orthogonal to the top surface of the glass tube but rather at an acute angle thereto. The laser then generated the welding emission. After the first welding emission, the glass tube was repositioned so that a second welding emission would enter the glass tube just adjacent to the first welding emission. After the second welding emission, the glass tube was again repositioned so that a third welding emission would enter the glass tube just adjacent to the second welding emission.

Each of the three welding emissions generated a vortex shaped melted volume into the glass tube. Each of the melted volumes included a vortex shaped void and terminated at a point through which a void axis extended. The void axis was aligned with the intended beam path of the welding emission. An image was captured of the three melted volumes. The image is reproduced at FIG. 19.

Example 3 – For Example 3, a glass workpiece that included a first glass tube placed layered against a second glass tube, having a convex-concave interface, was positioned in an intended beam path of a welding emission from a laser, with the top surface of the first glass tube to encounter the welding emission first. Focusing optics were manipulated so that the welding emission would converge to a beam waist preceding the outward facing surface (e.g., the top surface) of the first glass tube along the intended beam path. The welding emission would then be in a state of divergence before entering into the first glass tube at the outward facing surface thereof. Further, the glass workpiece and the intended beam path were positioned relative to each other so that the intended beam path was not orthogonal to the top surface of the first glass tube but rather at an acute angle thereto. The laser then generated the welding emission.

The welding emission generated an hourglass shaped void and laser weld volume therearound. The distinguishable laser weld volume reveals that the melted volume during the welding emission expanded while within the first glass tube to the interface with the inward primary surface of the second glass tube. Strong fusion between the first glass tube and the second glass tube resulted. An image was captured of the laser weld volume. The image is reproduced at FIG. 20. The white line extending left to right across the image is a reflection.

Example 4 – For Example 4, a glass workpiece in the form a fiber preform workpiece was assembled. The fiber preform workpiece included an outer preform cladding, an inner preform tube disposed within the outer preform cladding, and a nested preform capillary disposed within the inner preform tube. The fiber preform workpiece was positioned relative to an intended path of a welding emission from a laser so that the laser emission would encounter, in order, the inner capillary surface of the nested preform capillary, the capillary thickness, the outer capillary surface, the inner tube surface, the tube thickness, the outer tube surface, the inner cladding surface, and the cladding thickness. Focusing optics were adjusted so that the beam waist of the welding emission would precede the inner capillary surface. The intended beam path was set to be at an acute angle relative to the capillary axis (and thus the longitudinal axis of the fiber preform parallel thereto).

The welding emission induced a melted volume that cooled to form an hourglass shaped laser weld volume that extended through the capillary thickness, across the interface of the preform capillary and the inner preform tube, through the tube thickness, across the interface of the inner preform tube and the outer preform cladding, and at least onto the inner cladding surface of the outer preform cladding if not partially into the cladding thickness. Due in part to the beam waist preceding interaction with the fiber preform workpiece, the laser weld volume expanded while within the tube thickness toward the inner cladding surface of the preform outer cladding. Several images were captured of the laser weld volume. The images are reproduced at FIG. 21.

Example 5 – For Example 5, a glass workpiece in the form a fiber preform workpiece was assembled. The fiber preform workpiece included an outer preform cladding, an inner preform tube disposed within the outer preform cladding, and a nested preform capillary disposed within the inner preform tube. The fiber preform workpiece was positioned relative to an intended beam path of a welding emission from a laser so that the welding emission would encounter, in order, the outer capillary surface of the nested preform capillary, the capillary thickness, the capillary channel (e.g., an air gap), the inner capillary surface again, the capillary thickness again, the outer capillary surface again, the inner tube surface, the tube thickness, the outer tube surface, the inner cladding surface, and the cladding thickness. Focusing optics were adjusted so that the beam waist of the welding emission would precede the initial impingement upon the outer capillary surface of the nested preform capillary. The intended beam path was set to be at an acute angle relative to the capillary axis (and thus the longitudinal axis of the fiber preform parallel thereto).

The welding emission induced first an aperture through the capillary thickness where the welding emission initially impinged upon the outer capillary surface before reaching the capillary channel. After forming the aperture, the welding emission generated a melted volume that cooled to form a conical shaped laser weld that extended through the capillary thickness, across the interface of the preform capillary and the inner preform tube, through the tube thickness, across the interface of the inner preform tube and the outer preform cladding, and at least onto the inner cladding surface of the outer preform cladding if not partially into the cladding thickness. Due in part to the beam waist preceding interaction with the fiber preform workpiece, the laser weld volume expanded while within the tube thickness toward the inner cladding surface of the preform outer cladding. An image were captured of the laser weld volume and the aperture through the preform capillary. The images are reproduced at FIG. 22.

Example 6 – For Example 6, a glass workpiece in the form a fiber preform workpiece was assembled. The fiber preform workpiece included an outer preform cladding, an inner preform tube disposed within the outer preform cladding, and a nested preform capillary disposed within the inner preform tube. The fiber preform workpiece was positioned relative to an intended path of a welding emission from a laser so that the laser emission would encounter, in order, the outer capillary surface of the nested preform capillary, the capillary thickness, the capillary channel (e.g., an air gap), the inner capillary surface again, the capillary thickness again, the outer capillary surface again, the inner tube surface, the tube thickness, the outer tube surface, the inner cladding surface, and the cladding thickness. Focusing optics were adjusted so that the beam waist of the welding emission would not precede the initial impingement upon the outer capillary surface of the nested preform capillary (as in Example 5) but, rather, would reside within the cladding thickness. The intended beam path was set to be at an acute angle relative to the capillary axis (and thus the longitudinal axis of the fiber preform parallel thereto).

The welding emission induced first an aperture through the capillary thickness where the welding emission initially impinged upon the outer capillary surface before reaching the capillary channel. After forming the aperture, the welding emission generated a melted volume that cooled to form an hourglass shaped laser weld that extended through the capillary thickness, across the interface of the preform capillary and the inner preform tube, through the tube thickness, across the interface of the inner preform tube and the outer preform cladding, and at least onto the inner cladding surface of the outer preform cladding if not partially into the cladding thickness. An image were captured of the laser weld volume and the aperture through the preform capillary. The images are reproduced at FIG. 23.

It will be apparent to those skilled in the art that various modifications and variations can be made without departing from the spirit or scope of the claims.

What is claimed is:

1. A laser welded glass article comprising:
a first glass component comprising an inward primary surface and an outward primary surface;
a second glass component fused to the first glass component, the second glass component comprising an inward primary surface and an outward primary surface, the inward primary surface of the second glass component facing the inward primary surface of the first glass component; and
a laser weld volume fusing the first glass component and the second glass component together, the weld volume comprising an hourglass, vortex, or conical shaped perimeter.

2. The laser welded glass article of claim 1, wherein the laser weld volume defines a central void extending at least partially through the laser weld volume.

3. A fiber preform comprising:
a first preform end, a second preform end, and a longitudinal axis extending from the first preform end to the second preform end;
an outer preform cladding through which the fiber longitudinal axis extends, the outer preform cladding comprising an inner cladding surface facing and disposed radially around the longitudinal axis;
inner preform tubes coupled to the outer preform cladding at the inner cladding surface of the outer preform cladding, each of the inner preform tubes comprising (i) a tube axis extending therethrough parallel to the longitudinal axis of the fiber preform, (ii) an inner tube surface extending radially around the tube axis, and (iii) an outer tube surface facing away from the tube axis, and wherein the inner preform tubes collectively define a preform core that extends radially from the longitudinal axis and is tangential to the outer tube surface of each of the inner preform tubes; and
first laser weld volumes, each of the first laser weld volumes fusing a different one of the inner preform tubes to the outer preform cladding,
wherein, each of the first laser weld volumes comprises an hourglass, vortex, or conical perimeter.

4. The fiber preform of claim 3, further comprising:
nested preform capillaries, each of the nested preform capillaries disposed within a different one of the inner preform tubes, and each of the nested preform capillaries comprising (i) a capillary axis extending therethrough parallel to the tube axis of the inner preform tube within which the nested preform capillary is disposed, (ii) an inner capillary surface extending radially around the capillary axis, and (iii) an outer capillary surface facing away from the capillary axis,
wherein, each of third laser weld volumes fuse a different one of the nested preform capillaries to the inner preform tube within which the nested preform capillary is disposed, each of the third laser weld volumes comprising an hourglass, vortex, or conical perimeter.

5. The fiber preform of claim 4, wherein each of the nested preform capillaries further comprises an aperture.

6. The fiber preform of claim 3, wherein each of the first laser weld volumes comprises a central void extending at least partially therethrough.

7. The fiber preform of claim 3, wherein
each of the first laser weld volumes is substantially symmetrical about a weld axis, and
the weld axis is not orthogonal to the longitudinal axis of the fiber preform.

8. The fiber preform of claim 3, wherein the outer preform cladding and each of the inner preform tubes comprise one or more of silica, doped silica, fluorine-doped borosilicate glass, borosilicate glass, soda-lime glass, and aluminosilicate glass.

9. The fiber preform of claim 3, further comprising:
nested preform capillaries, each of the nested preform capillaries disposed within a different one of the inner preform tubes, and each of the nested preform capillaries comprising (i) a capillary axis extending therethrough parallel to the tube axis of the inner preform tube within which the nested preform capillary is disposed, (ii) an inner capillary surface extending radially around the capillary axis, and (iii) an outer capillary surface facing away from the capillary axis;
wherein, each of third laser weld volumes fuses a different one of the nested preform capillaries to the inner preform tube within which the nested preform capillary is disposed, each of the third laser weld volumes proximate the first preform end and comprising an hourglass, vortex, or conical perimeter, and
wherein, each of fourth laser weld volumes fuses a different one of the nested preform capillaries to the inner preform tube within which the nested preform capillary is disposed, each of the fourth laser weld volumes proximate the second preform end and comprising an hourglass, vortex, or conical perimeter.

10. A method of manufacturing a laser welded glass article comprising:
a workpiece positioning step comprising positioning a glass workpiece in an intended beam path of a welding emission from a laser, the glass workpiece comprising multiple glass components including at least a first glass component and a second glass component, the first glass component positioned to encounter the welding emission along the intended beam path before the second glass component, and
a laser welding step comprising causing the laser to emit the welding emission along the intended beam path,
wherein, the welding emission converges to a beam waist,
wherein, the welding emission causes one or both of the first glass component or the second glass component to increase in temperature and to decrease in viscosity so as to flow and fuse the first glass component and the second glass component together throughout a laser weld volume, and
wherein, the beam waist is not coextensive with the laser weld volume.

11. The method of claim 10, wherein the welding emission diverges from the beam waist before impinging upon the first component.

12. The method of claim 10, wherein the beam waist is disposed within the second glass component.

13. The method of claim 10, wherein
before the laser welding step, a gap separates the first glass component and the second glass component along the intended beam path, and
after the laser welding step, the laser weld volume at least partially fills the gap.

14. The method of claim 10, wherein during the workpiece positioning step, the workpiece and the intended beam path are positioned relative to each other so that the intended beam path is not orthogonal to an inward primary surface of the second glass component.

15. The method of claim 10, wherein
the multiple glass components of the glass workpiece further includes a third glass component, the third glass component positioned to encounter the welding emission along the intended beam path, and
the welding emission causes one or more of the first glass component, the second glass component, and the third glass component to increase in temperature and to decrease in viscosity so as to flow and fuse the first glass component, the second glass component, and the third glass component together throughout the laser weld volume.

16. The method of claim 15, wherein during the laser welding step, the welding emission forms an aperture through the third component.

17. The method of claim 10, wherein the laser emits the welding emission with a power sufficient to enable thermal lensing of the weld emission in one or both of the first glass component or the second glass component.

18. The method of claim 17, wherein
the beam waist is positioned along the intended beam path between the laser and the first glass component, and
the thermal lensing of the weld emission occurs in the first glass component.

19. The method of claim 17, wherein the thermal lensing of the weld emission produces the laser weld volume.

20. The method of claim 17, wherein the power of the welding emission is insufficient to induce non-linear effects in either the first glass component or the second glass component.
